(19) United States
(12) Patent Application Publication
(10) Pub. No.: US 2024/0241459 A1
(43) Pub. Date: Jul. 18, 2024

(54) IMAGE FORMING APPARATUS, ADHESIVE CARTRIDGE, ADHESIVE CONTAINER, AND PROCESS CARTRIDGE SET

(71) Applicant: CANON KABUSHIKI KAISHA, Tokyo (JP)

(72) Inventors: TAKU WATANABE, Shizuoka (JP); KOHEI MATSUDA, Kanagawa (JP); ATSUSHI TODA, Shizuoka (JP); SHUN SATO, Kanagawa (JP); HIRAKU SASAKI, Shizuoka (JP); KENTARO KAWATA, Shizuoka (JP)

(21) Appl. No.: 18/609,729

(22) Filed: Mar. 19, 2024

Related U.S. Application Data
(63) Continuation of application No. PCT/JP2022/034218, filed on Sep. 13, 2022.

(30) Foreign Application Priority Data
Sep. 30, 2021 (JP) 2021-160530

(51) Int. Cl. G03G 9/097; G03G 9/08

(52) U.S. Cl. CPC G03G 9/09733; G03G 9/0819; G03G 2215/0624; G03G 2221/183

(57) ABSTRACT

An image forming apparatus which comprises a first image forming unit for forming a toner image for printing by means of a toner for printing and an adhesive image forming unit for forming an image of a powder adhesive by means of a powder adhesive, and which is characterized in that: the toner for printing contains a wax; the powder adhesive contains a wax; and the content of the wax in the powder adhesive is higher than the content of the wax in the toner for printing.

### CROSS-REFERENCE TO RELATED APPLICATION

This is a continuation of International Application No. PCT/JP2022/034218, filed on Sep. 13, 2022, and designated the U.S., and claims priority from Japanese Patent Application No. 2021-160530 filed on Sep. 30, 2021, the entire contents of which are incorporated herein by reference.

### BACKGROUND OF THE INVENTION

### Field of the Invention

The present disclosure relates to an image forming apparatus that develops an electrostatic latent image on a transfer material, relying on an electrophotographic method, to form a toner image and a bonded portion using a powder adhesive that functions as an adhesive, and further relates to an adhesive cartridge, an adhesive container and a process cartridge set that are used in the above image forming apparatus.

### Description of the Related Art

To conventionally create documents such as pay slips having confidential content and that need to be sealed, pre-printed paper is prepared beforehand, and variable data is printed on each individual pre-printed paper sheet, further followed by post-processing in the form of a sealing treatment. Production of pre-printed paper according to such a scheme takes time on account of the need for printing form formats such as ruled lines, and the need for applying an adhesive; moreover, the scheme is costly and inefficient for applications where the required print runs are small.

Japanese Patent Application Publication Nos. 2008-036957 and 2008-162029 disclose execution of an electrophotographic process by using printing toner and a resin powder having an adhesive function (hereafter referred to as powder adhesive), on a sheet-shaped bag material. Accordingly, a bag making apparatus has been proposed that outputs a bag-shaped deliverable, thus dispensing with the step of preparing pre-printed paper. In these bag making apparatuses, printing toner and a powder adhesive are transferred onto a sheet and are thereafter heat-fixed onto the sheet, followed by folding of the sheet and by a subsequent pressure-bonding process in which the sheet is pressed while being heated, to produce thus a bag-shaped deliverable.

Japanese Patent Application Publication No. 2015-028592 describes enhancing adhesive strength by setting the amount of powder adhesive per unit area to be larger than that of printing toner, in a powder image that is formed on a recording medium.

### SUMMARY OF THE INVENTION

However, studies by the inventors have revealed that sufficient adhesive strength may fail to be achieved, in the above bag making apparatuses, in a case where the laying amount of powder adhesive per unit area relative to the sheet is increased so as to achieve a stronger adhesive strength. In a case where a powder adhesive is used in a developing apparatus of one-component developing type having a developer bearing member and a regulating member, moreover, fogging occurs when attempting to increase the laying amount of powder adhesive on a recording medium by increasing the laying amount of powder adhesive per unit area on the developer bearing member.

The above documents mention nothing concerning drops in adhesive strength that occur when the laying amount of the powder adhesive per unit area of the sheet is increased, or concerning countermeasures against such drops in adhesive strength. In addition, the above documents do not indicate that in using a powder adhesive in a developing apparatus of one-component developing type having a developer bearing member and a regulating member, fogging is prone to occur when increasing the laying amount of powder adhesive on the developer bearing member.

The present disclosure provides an image forming apparatus that allows suppressing the occurrence of fogging, while enhancing adhesive strength, also when laying amounts per unit area on a sheet are increased, and to provide an adhesive cartridge, an adhesive container and a process cartridge set that are utilized in the image forming apparatus.

The present disclosure relates to an image forming apparatus, comprising:
a first image forming section for forming a printing toner image by a printing toner; and
a second image forming section for forming a powder adhesive image by a powder adhesive,
wherein the printing toner comprises a wax;
the powder adhesive comprises a wax; and
a content of the wax in the powder adhesive is higher than a content of the wax in the printing toner.

The present disclosure succeeds in providing an image forming apparatus that allows enhancing adhesive strength, and suppressing fogging, also when laying amounts per unit area on a sheet are increased. Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to Example 1;

FIG. 2 is a diagram for explaining attachment of a post-processing unit to the body of an image forming apparatus;

FIG. 3 is a schematic diagram for explaining the state of a toner image transferred to a sheet;

FIG. 4A and FIG. 4B are diagrams illustrating a sheet transport path in an image forming apparatus;

FIG. 5A to FIG. 5F are diagrams for explaining the particulars of a folding process according to Example 1;

FIG. 6 is a perspective-view diagram illustrating the appearance of the image forming apparatus according to Example 1;

FIG. 7A and FIG. 7B are diagrams illustrating a deliverable that is outputted by the image forming apparatus according to Example 1;

FIG. 8 is a schematic diagram of a process cartridge according to Example 1;

FIG. 9A is a schematic diagram for explaining a tensile test method according to Example 1;

FIG. 9B and FIG. 9C are diagrams for explaining a tensile test method according to Example 1;

FIG. 10 is a stress-strain curve graph obtained in a tensile test according to Example 1;

FIG. 11 is a schematic diagram illustrating the position of the end of a developing blade 107;

FIG. 12 is a graph of a comparison of M/Stotal and adhesive strength according to Example 1;

FIG. 13 is a schematic diagram of a measuring device of an attachment force according to Example 1;

FIG. 14 is a graph illustrating a relationship between the weight-average particle diameter and the peel-off force of a powder adhesive;

FIG. 15 is a schematic diagram of an image forming apparatus according to Example 2;

FIG. 16A and FIG. 16B are schematic diagrams of a booklet-shaped deliverable according to Example 2;

FIG. 17 is a schematic diagram of an image forming apparatus according to Example 3; and

FIG. 18 is a schematic diagram of a corner-bound booklet-shaped deliverable according to Example 3.

### DESCRIPTION OF THE EMBODIMENTS

Preferred embodiments of the present invention will be explained in detail below by way of examples with reference to accompanying drawings. Unless otherwise specified, however, the dimensions, materials, shapes, relative arrangements and so forth of the constituent elements described in the embodiments are not meant to limit the scope of the present invention to these embodiments alone. Unless noted otherwise, the materials, shapes and so forth of members having been explained once in the following description are identical, in a later explanation, to those in the first explanation.

In the present disclosure, unless specifically indicated otherwise, the expressions “from XX to YY” and “XX to YY” that show numerical value ranges refer in the present disclosure to numerical value ranges that include the lower limit and upper limit that are the end points. When numerical value ranges are provided in stages, the upper limits and lower limits of the individual numerical value ranges may be combined in any combination.

### EXAMPLES

### Example 1

### Overall Apparatus Configuration

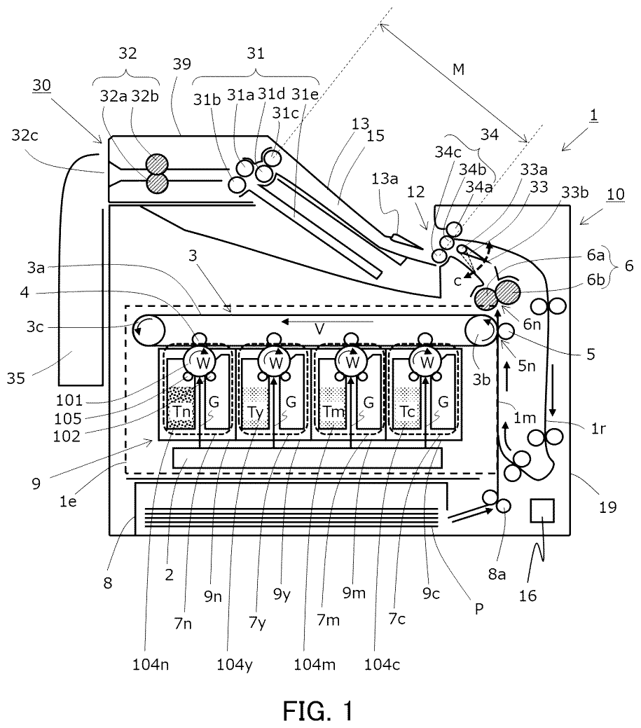

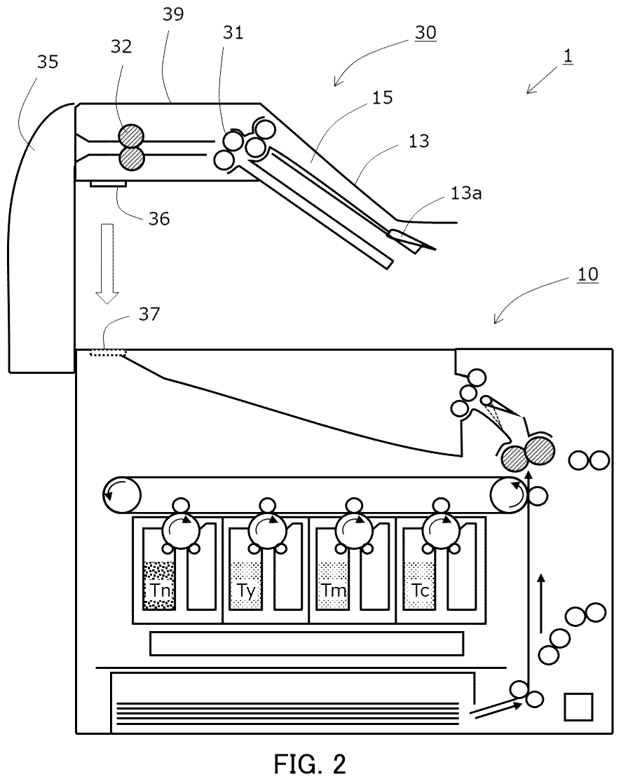

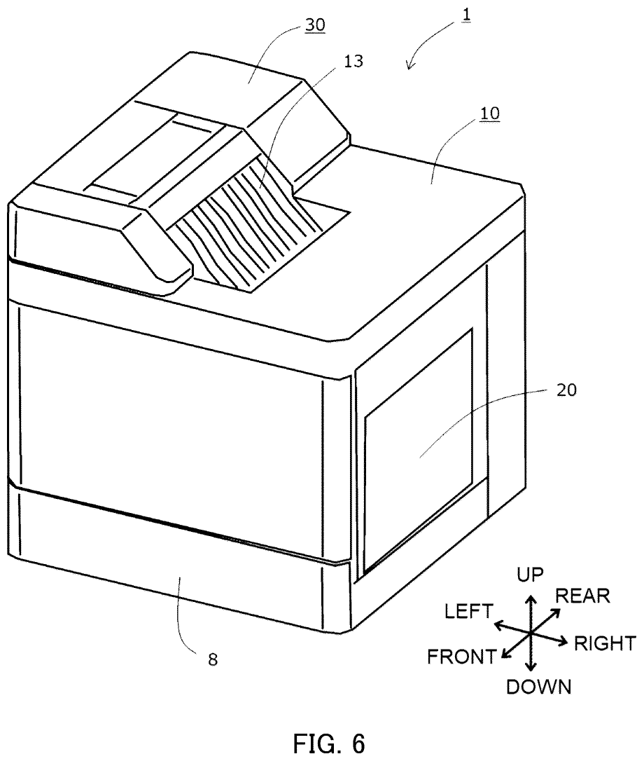

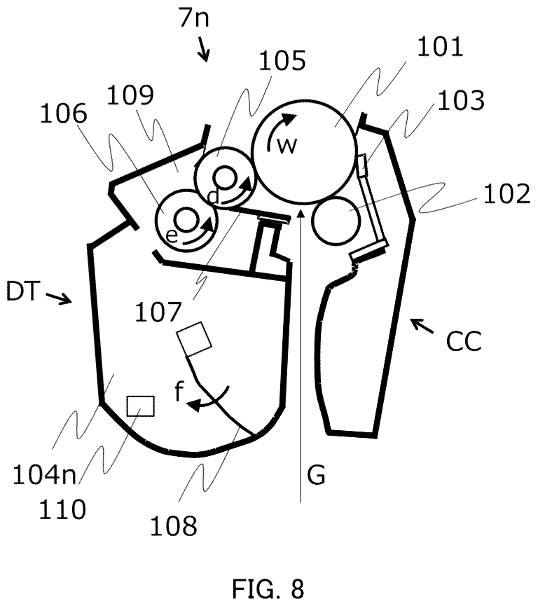

The overall configuration of the image forming apparatus will be explained first with reference to FIG. 1, FIG. 2, FIG. 6 and FIG. 8. FIG. 1 is a schematic diagram illustrating the cross-sectional configuration of an image forming apparatus 1 that includes an image forming apparatus body (hereafter referred to as apparatus body 10) and a post-processing unit 30 connected to the apparatus body 10. The image forming apparatus 1 is an electrophotographic image forming apparatus (electrophotographic system) made up of the apparatus body 10 having an electrophotographic printing mechanism, and the post-processing unit 30 as a sheet processing device.

The image forming apparatus 1 in the present Example has: an image forming means (image forming unit 1e) provided with a print image forming section (process cartridges 7y, 7m, 7c) as a first image forming section for forming a printing toner image by a printing, toner, and with an adhesive image forming section (process cartridge 7n) as a second image forming section for forming a powder adhesive image by a powder adhesive; a transfer means 3 for transferring the printing toner image and the powder adhesive image to a transfer material (sheet P); and a fixing means 6 for fixing, onto the transfer material, the printing toner image and the powder adhesive image transferred to the transfer material.

The print image forming section (process cartridges 7y, 7m, 7c) is detachably mountable to the body of the apparatus. At least some of the structures (for instance photosensitive drum and/or developing roller) of the process cartridges (7y, 7m, 7c) that make up the print image forming section may be fixed to the body of the apparatus.

The adhesive image forming section (process cartridge 7n) is detachably mountable to the body of the apparatus. Similarly, at least some structure (for instance photosensitive drum and/or developing roller) of the process cartridge (7n) that make up the adhesive image forming section may be fixed to the body of the apparatus.

The print image forming section may have a first image bearing member (first photosensitive member), and a first developer bearing member developing, with printing toner, an electrostatic latent image formed on the first image bearing member. The adhesive image forming section may have a second image bearing member (second photosensitive member) and a second developer bearing member developing, with a powder adhesive, the electrostatic latent image formed on the second image bearing member.

FIG. 2 is a cross-sectional diagram illustrating a positioning portion at a time where the post-processing unit 30 is attached to the apparatus body 10. The post-processing unit 30 can be detachably and mountably attached to the apparatus body 10. The post-processing unit 30 can be attached to the apparatus body 10 through fitting of a connector 36 of the post-processing unit 30 to a connector 37 of the apparatus body 10.

FIG. 6 is a perspective-view diagram illustrating the appearance of the image forming apparatus 1. FIG. 8 is a schematic diagram of a process cartridge. As illustrated in FIG. 6, the post-processing unit 30 is attached at the top of the apparatus body 10. The image forming apparatus 1 has a sheet cassette 8 at the bottom, an openable/closable tray 20 on the right side, and a first discharge tray 13 at the top.

The internal configuration of the apparatus body 10 will be explained first. As illustrated in FIG. 1, the apparatus body 10 is provided with a sheet cassette 8 as a sheet accommodating section for accommodating sheets P which are a transfer material (recording medium), an image forming unit 1e as an image forming means, a first fixing unit 6 as a fixing means, and a housing 19 that accommodates the foregoing. The apparatus body 10 has a printing function of forming a toner image, by the image forming unit 1e, on sheets P that are fed from the sheet cassette 8, and producing a printed product resulting from a fixing process by the first fixing unit 6.

The sheet cassette 8, which is inserted into the housing 19 at the bottom of the apparatus body 10 so as to be withdrawable therefrom, accommodates a large number of sheets P. The sheets P accommodated in the sheet cassette 8 are fed from the sheet cassette 8 by a feeding member such as a feeding roller, and are conveyed by the transport roller 8a in a state of having been separated one by one by a separating roller pair. Likewise, sheets set on an open tray 20 (FIG. 6) can be fed one by one.

The image forming unit 1e is a tandem-type electrophotographic unit provided with four process cartridges 7n, 7y, 7m, 7c, a scanner unit 2, and a transfer unit 3. The term process cartridge denotes a unit in which multiple components involved in the image forming process have been integrally and replaceably configured into a unit.

The apparatus body 10 is provided with a cartridge support portion 9 that is supported by the housing 19, such that the process cartridges 7n, 7y, 7m, 7c are detachably and mountably attached to respective mounting portions 9n, 9y, 9m, 9c provided in the cartridge support portion 9. The cartridge support portion 9 may be a tray member that can be withdrawn from the housing 19.

The process cartridges 7n, 7y, 7m, 7c have a substantially shared configuration, except for the type of powder accommodated in the four powder accommodating sections 104n, 104y, 104m, 104c. Specifically, each process cartridge 7n, 7y, 7m, 7c has a respective photosensitive drum 101 which is an image bearing member, a respective charging roller 102 which is a charging device, a powder accommodating section 104n, 104y, 104m, 104c in which a respective powder is accommodated, and a respective developing roller 105 for developing using that powder.

From among the four powder accommodating sections, the three powder accommodating sections 104y, 104m, 104c on the right side of the figure have respectively accommodated therein printing toners Ty, Tm, Tc for yellow, magenta and cyan, as toners (first powder) for forming a visible image on the sheets P. Meanwhile, a powder adhesive Tn, which is a powder (second powder) for performing a bonding process after printing, is accommodated in the powder accommodating section 104n on the leftmost side in the figure.

The powder accommodating sections 104y, 104m, 104c all are examples of a first toner cartridge that accommodates respective printing toners Ty, Tm, Tc. The powder accommodating section 104n is an example of a second toner cartridge that accommodates a powder adhesive. The process cartridges 7y, 7m, 7c all are examples of a first process cartridge that forms a toner image using a printing toner, and the process cartridge 7n is an example of a second process cartridge that forms a powder adhesive image according to a predetermined application pattern.

Appropriate voltage as instructed by a control unit (not shown) on the basis of the detection result by a temperature/humidity sensor 16 and on the basis of life information stored in a non-volatile memory 110 held in each process cartridges 7y, 7m, 7c, 7n illustrated in FIG. 8 is applied, by a voltage application means, not shown, to each developing roller 105, developer supply roller 106, developing blade 107, charging roller 102 illustrated in FIG. 8, and to the transfer means (transfer unit) 3 and secondary transfer roller 5 illustrated in FIG. 1.

When printing a black image such as text, the image is expressed in process black in which yellow (Ty), magenta (Tm), and cyan (Tc) toners are superimposed. However, for example, a fifth process cartridge that uses a black printing toner may be added to the image forming unit 1e so that the black image can be expressed by the black printing toner. Such options are not limiting, and the type and number of printing toners can be changed according to the application of the image forming apparatus 1.

The scanner unit 2 is arranged below the process cartridges 7n, 7y, 7m, and 7c and above the sheet cassette 8. The scanner unit 2 is an exposure means for irradiating the photosensitive drum 101 of each process cartridge 7n, 7y, 7m, and 7c with laser light G and writing an electrostatic latent image.

The transfer unit 3 includes a transfer belt 3a as an intermediate transfer body (secondary image bearing member). The transfer belt 3a is a belt member wound around a secondary transfer inner roller 3b and a tension roller 3c, and faces the photosensitive drum 101 of each process cartridge 7n, 7y, 7m, and 7c on the outer peripheral surface.

On the inner peripheral side of the transfer belt 3a there are arranged primary transfer rollers 4, at positions corresponding to respective photosensitive drums 101. Further, a secondary transfer roller 5 as a transfer means is arranged at a position opposing the secondary transfer inner roller 3b. A transfer nip 5n between the secondary transfer roller 5 and the transfer belt 3a is a transfer section (secondary transfer section) in which the toner image is transferred from the transfer belt 3a to the sheet P.

The first fixing unit 6 is arranged above the secondary transfer roller 5. The first fixing unit 6 is a heat fixing type fixing unit having a heat roller 6a as a heating member and a pressure roller 6b as a pressing member. The heat roller 6a is heated by a heat generating element such as a halogen lamp, a ceramic heater or a heating mechanism of induction heating type. The pressure roller 6b is pressed against the heat roller 6a by an urging member such as a spring, and generates a pressurizing force that pressurizes the sheet P passing through the nip portion (fixing nip 6n) of the heat roller 6a and the pressure roller 6b.

The housing 19 is provided with a discharge port 12 (first discharge port), which is an opening for discharging the sheet P from the apparatus body 10, and a discharge unit 34 is arranged in the discharge port 12. The discharge unit 34, which is a discharge means, uses a so-called triple roller having a first discharge roller 34a, an intermediate roller 34b, and a second discharge roller 34c.

Further, a switching guide 33, which is a flap-shaped guide for switching the transport path of the sheet P, is provided between the first fixing unit 6 and the discharge unit 34. The switching guide 33 is rotatable around a shaft portion 33a so that a tip 33b reciprocates in the direction of arrow c in the figure.

The apparatus body 10 is provided with a mechanism for performing double-sided printing. A motor (not shown) is connected to the discharge unit 34 and configured so that the rotation direction of the intermediate roller 34b can be forward and reverse. Further, a double-sided transport path Ir is provided as a transport path connected in a loop to a main transport path 1m. The sheet P where an image has been formed on the first surface while passing through the main transport path 1m is nipped and transported by the first discharge roller 34a and the intermediate roller 34b with the switching guide 33 which is rotated clockwise.

After the rear end of the sheet P in the traveling direction passes through the switching guide 33, the switching guide 33 rotates counterclockwise, the intermediate roller 34b reverses, and the sheet P is reversely transported to the double-sided transport path 1r. Then, an image is formed on the second surface of the sheet P while the sheet P passes through the main transport path 1m again with the front and back reversed.

The sheet P after double-sided printing is nipped and transported by the intermediate roller 34b and the second discharge roller 34c with the switching guide 33 rotated counterclockwise, and is discharged from the apparatus body 10. Further, the transport path passing through the transport roller 8a, the transfer nip 5n, and the fixing nip 6n in the apparatus body 10 constitutes the main transport path 1m in which an image is formed on the sheet P. The main transport path 1m extends from the bottom to the top through one side in the horizontal direction with respect to the image forming unit 1e when viewed from the main scanning direction (the width direction of the sheet perpendicular to the transport direction of the sheet transported along the main transport path 1m) at the time of image formation.

In other words, the apparatus body 10 is a so-called vertical transport type (vertical path type) printer in which the main transport path 1m extends in a substantially vertical direction. When viewed in the vertical direction, the first discharge tray 13, the intermediate path 15, and the sheet cassette 8 overlap each other. Therefore, the moving direction of the sheet when the discharge unit 34 discharges the sheet P in the horizontal direction is opposite to the moving direction of the sheet when the sheet P is fed from the sheet cassette 8 in the horizontal direction.

Further, from the viewpoint of FIG. 1 (a view in the main scanning direction at the time of image formation), it is preferable that the horizontal occupied range of the main body portion of the post-processing unit 30 excluding the second discharge tray 35 fit into the occupied range of the apparatus body 10. By fitting the post-processing unit 30 in the space above the apparatus body 10 in this way, the image forming apparatus 1 having an adhesive printing function can be installed in about the same installation space as a normal vertical path printer.

### Bonding Unit

As shown in FIG. 2, the post-processing unit 30 is attached to the top of the apparatus body 10. In the post-processing unit 30, a folding device 31 as a folding means and the second fixing unit 32 as an adhesive bonding means (second fixing means) are accommodated in a housing (second housing) 39 and integrated.

Further, the post-processing unit 30 is provided with a first discharge tray 13 for rotatably holding the tray switching guide 13a, an intermediate path 15, and a second discharge tray 35. The first discharge tray 13 is provided on the upper surface of the post-processing unit 30, and is located on the top face (FIG. 1) of the entire image forming apparatus 1. The functions of each part included in the post-processing unit 30 will be described hereinbelow.

The post-processing unit 30 has a positioning portion (for example, a convex shape that engages with a concave portion of the housing 19) for positioning the housing 39 with respect to the housing 19 (first housing) of the apparatus body 10. Further, the post-processing unit 30 is provided with a drive source and a control unit separate from the apparatus body 10, and the connector 36 of the post-processing unit 30 and the connector 37 of the apparatus body 10 are joined together to electrically connect the post-processing unit to the apparatus body 10. As a result, the post-processing unit 30 is brought into an operating state based on a command from the control unit provided in the apparatus body 10 by using the electric power supplied through the apparatus body 10.

### Cartridge Set

In the present Example a cartridge set includes first cartridges (7y, 7m, 7c) that make up the print image forming section and a second cartridge 7n (adhesive cartridge) that makes up the adhesive image forming section. In other words, in the image forming apparatus 1 the print image forming section includes the first cartridge, and the adhesive image forming section includes the second cartridge.

The first cartridge includes the first developer bearing member that bears printing toner. The first cartridge may include the first image bearing member that bears a printing toner image formed by the printing toner born on the first developer bearing member. The first image bearing member can carry an electrostatic latent image. The first cartridge also includes a toner container (powder accommodating sections 104y, 104m, 104c) that accommodates printing toner, the first image bearing member (first photosensitive member), and the first developer bearing member (first developing roller) developing, with the printing toner, an electrostatic latent image formed on the first image bearing member. The first image bearing member is a photosensitive member 101 in a respective first cartridge (7y, 7m, 7c). The first developing roller is the developing roller 105 in a respective first cartridge (7y, 7m, 7c).

The second cartridge includes a second developer bearing member that bears a powder adhesive. The second cartridge may have a second image bearing member that bears an adhesive image formed by the powder adhesive born on the second developer bearing member. The second image bearing member can carry an electrostatic latent image. The second cartridge includes a powder adhesive container (104n) that accommodates a powder adhesive, a second image bearing member (second photosensitive member) (101), and a second developer bearing member (second developing roller) (105) developing, with the powder adhesive, an electrostatic latent image formed on the second image bearing member. The first cartridge and the second cartridge may have the developing blade 107 as a developer regulating member that regulates the layer thickness of the printing toner or the powder adhesive.

### Process Cartridge

As described above, the process cartridges 7n, 7y, 7m, 7c have substantially a shared configuration, except for the types of powder accommodated in the four powder accommodating sections 104n, 104y, 104m, 104c. The process cartridge 7n will be explained here as a representative instance of the process cartridges. FIG. 8 is a schematic cross-sectional diagram of the process cartridge 7n. The process cartridge 7n is made up of a photosensitive member unit CC provided with the photosensitive drum 101 or the like, and a developing unit DT provided with the developing roller 105 or the like.

The photosensitive drum 101 is rotatably attached to the photosensitive member unit CC via a bearing, not shown. In the photosensitive drum 101, a φ24 mm-diameter aluminum cylinder has applied thereonto an undercoat layer, an insulating layer, a photosensitive layer and a charge transport layer, so that an electrostatic latent image can be formed on the surface of the photosensitive drum 101. Further, the photosensitive drum 101 is rotationally driven at 300 mm/sec in the clockwise (arrow w) in the figure, in accordance with the image forming operation, by receiving the driving force of a drive motor as a driving means (drive source), not shown. The photosensitive member unit CC has further disposed therein, around the photosensitive drum 101, a charging roller 102 for charging the photosensitive drum 101, and a cleaning member 103.

The developing unit DT is provided with a developing roller 105 as a developer bearing member that comes into contact with the photosensitive drum 101 and rotates counter-clockwise (arrow d) in the figure. In the developing roller 105, a φ12 mm-diameter conductive rubber is disposed around a core metal. The developing roller 105 and the photosensitive drum 101 rotate so that surfaces thereof at the portion (contact portion) where the surfaces oppose each other move in a same direction. The rotational speed of the developing roller 105 was set, at 450 mm/sec, to be higher than that of the photosensitive drum 101.

Further, the developing unit DT has disposed therein a developer supply roller 106 (hereafter simply referred to as a “supply roller”) as a developer supply member that rotates at 320 mm/sec in the counter-clockwise (arrow e) in the figure. In the supply roller 106 a φ13 mm-diameter conductive sponge is disposed around a core metal. The supply roller 106 and the developing roller 105 rotate in such a manner that surfaces thereof, at a portion (contact portion) where the surfaces oppose each other, move in the same direction.

The supply roller 106 elicits the action of supplying the powder adhesive (printing toners Ty, Tm, Tc in the case of the process cartridges 7y, 7m, 7c) onto the developing roller 105, and the action of scraping, off the developing roller 105, powder adhesive (printing toners Ty, Tm, Tc in the case of the process cartridges 7y, 7m, 7c) remaining on the developing roller 105.

In the developing unit DT there is further disposed the developing blade 107 as a developer regulating member which regulates the layer thickness of the powder adhesive (printing toners Ty, Tm, Tc in the case of the process cartridges 7y, 7m, 7c) that is supplied onto the developing roller 105 by the supply roller 106.

The rotation direction of the supply roller 106 is inconsequential so long as the toner on the developing roller 105 can be scraped off and can be supplied onto the developing roller 105.

Each powder accommodating section 104n accommodates a powder in the form of a respective powder adhesive (printing toners Ty, Tm, Tc in the case of the process cartridges 7y, 7m, 7c). A rotatably supported stirring member 108 is provided within the powder accommodating section 104n. The stirring member 108 rotates clockwise (arrow f) in the figure, to thereby stir the powder accommodated in the powder accommodating section 104n, and transport the powder to a developing chamber 109 in which the developing roller 105 and the supply roller 106 are provided.

A configuration can also be adopted in which the photosensitive member unit CC and the developing unit DT are separate from each other and respectively constitute a photosensitive member unit cartridge and a developing unit cartridge that are detachably mountable to the image forming apparatus body. Another configuration can be adopted that includes just the powder accommodating section 104 and the stirring member 108, which make up a powder cartridge that is detachably mountable to the apparatus body.

For instance there can be configured a developing unit cartridge set detachably mountable to the image forming apparatus 1 and that includes a first developing unit cartridge and a second developing unit cartridge. The first developing unit cartridge has a toner container that accommodates a printing toner, a first developing roller that develops, with printing toner, an electrostatic latent image formed on the photosensitive member, and a developing blade as a developer regulating member that regulates the layer thickness of the printing toner on the first developing roller. The second developing unit cartridge has a powder adhesive container that accommodates a powder adhesive, a second developing roller that develops, with a powder adhesive, an electrostatic latent image formed on the photosensitive member, and a developing blade as a developer regulating member that regulates the layer thickness of the powder adhesive on the second developing roller.

For instance a toner cartridge set can be configured that has a first toner cartridge and a second toner cartridge which can be attached/detached to/from the image forming apparatus 1. The first toner cartridge, which is detachably and mountably attached to the print image forming section, accommodates a printing toner. The second toner cartridge, provided in the adhesive image forming section, accommodates a powder adhesive.

Another aspect of the present disclosure provides an adhesive cartridge as a cartridge 7n containing a powder adhesive. The adhesive cartridge is detachably mountable to an adhesive image forming section of an image forming apparatus that has a print image forming section in which a printing toner image is formed by a printing toner that contains a wax and an adhesive image forming section in which a powder adhesive image is formed by a powder adhesive. The adhesive cartridge, as an adhesive image forming section, forms a powder adhesive image by a powder adhesive. The powder adhesive comprises a wax, such that a content of the wax in the powder adhesive is higher than a content of the wax in the printing toner. The adhesive cartridge has a second developer bearing member developing, with a powder adhesive, an electrostatic latent image formed on a second image bearing member (second photosensitive member). The second image bearing member may be provided, in the image forming apparatus, at a position other than that of the adhesive cartridge, or may be included in the adhesive cartridge. The adhesive cartridge may have the second image bearing member (second photosensitive member), a second developing roller developing, with a powder adhesive, an electrostatic latent image formed on the second image bearing member (second photosensitive member), and a developing blade as a developer regulating member that regulates the layer thickness of the powder adhesive on the second developing roller.

The present disclosure provides an adhesive container, as the powder accommodating section 104n. The adhesive container is detachably mountable to the image forming apparatus that is provided with the print image forming section for forming a printing toner image by a printing toner that comprises a wax, and the adhesive image forming section for forming a powder adhesive image by a powder adhesive. The adhesive container is provided with the powder accommodating section 104n that accommodates a powder adhesive. The powder adhesive accommodated in the powder accommodating section comprises a wax, such that a content of the wax in the powder adhesive is higher than a content of the wax in the printing toner.

### Image Forming Operation

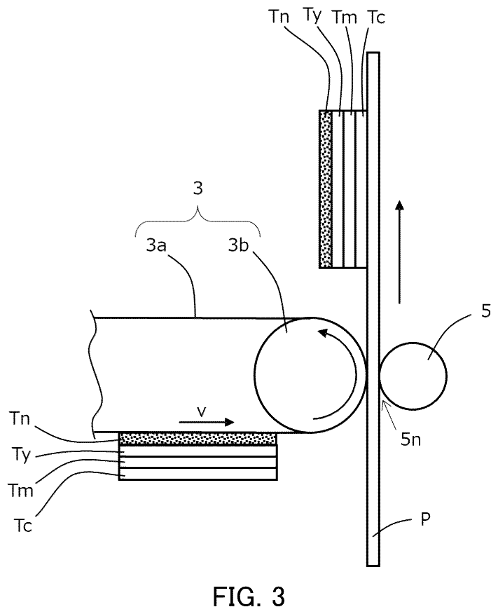

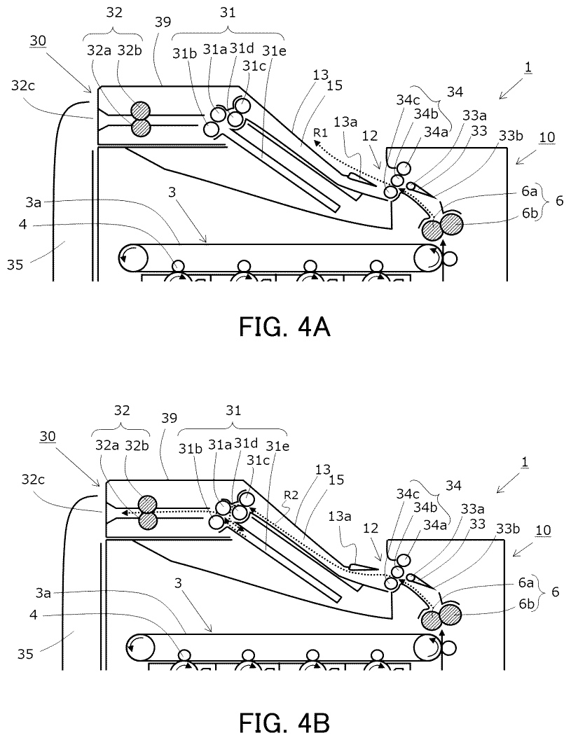

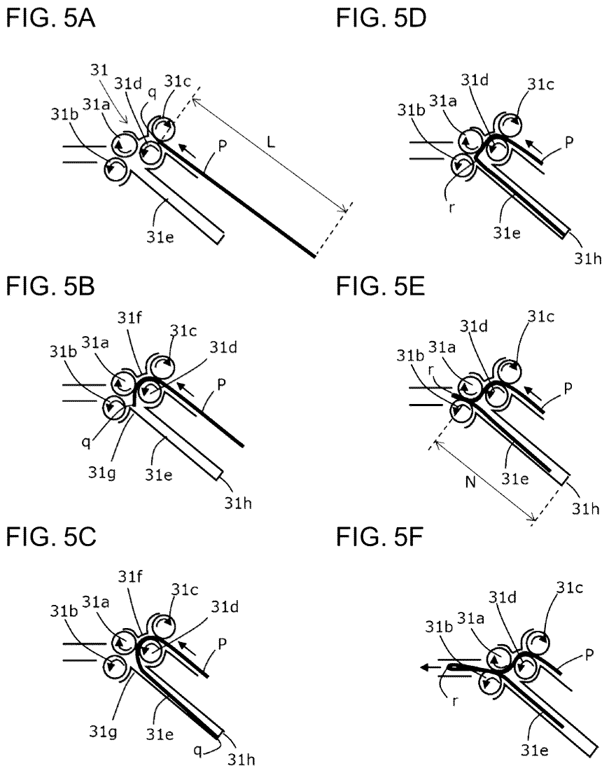

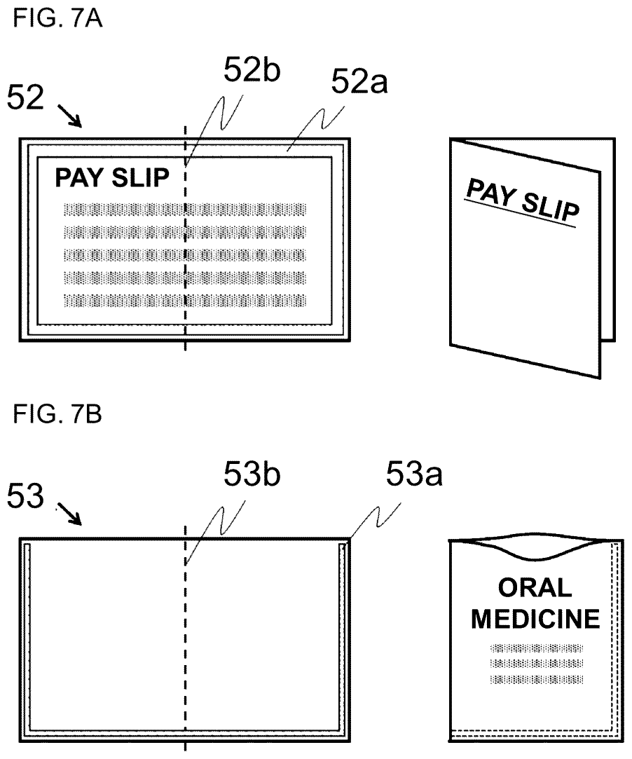

An image forming operation performed by the image forming apparatus 1 will be explained next with reference to FIG. 1 to FIG. 8. FIG. 3 is a schematic diagram for explaining the state of a toner image transferred to a sheet P. FIG. 4A and FIG. 4B are diagrams illustrating sheet transport paths in the image forming apparatus 1. FIG. 5A to FIG. 5F are diagrams for explaining the details of a folding process. FIG. 7A and FIG. 7B are diagrams illustrating a deliverable that is outputted by the image forming apparatus 1.

When data of an image to be printed and a print execution command are inputted to the image forming apparatus 1, the control unit (not shown) of the image forming apparatus 1 transports the sheets P and forms an image, and if necessary, initiates a series of operations (image forming operation) for execution of post-processing by the post-processing unit 30. In the image forming operation, firstly the sheets P are fed one by one from the sheet cassette 8, and are transported toward the transfer nip 5n via the transport roller 8a, as illustrated in FIG. 1.

In parallel with the feeding of each sheet P, the process cartridges 7n, 7y, 7m, 7c are sequentially driven, and each photosensitive drum 101 is rotationally driven clockwise (arrow w) in the figure. The surface of the photosensitive drum 101 becomes uniformly charged thereupon by the charging roller 102.

Further, the scanner unit 2 irradiates the photosensitive drum 101 of each process cartridge 7n, 7y, 7m, 7c with the laser beam G having been modulated on the basis of the image data, to thereby form a respective electrostatic latent image on the surface of each photosensitive drum 101. Next, the electrostatic latent image on each photosensitive drum 101 is developed, as a powder image, by the powder supported on the respective developing roller 105 of each process cartridge 7n, 7y, 7m, 7c.

The powder adhesive layer that is formed on each photosensitive drum 101 by being developed with the powder adhesive Tn differs from the toner image (ordinary toner image) of the printing toners Ty, Tm, Tc for recording an image such as figures or text on the sheet P, in that the powder adhesive layer is not intended to convey visual information. In the explanation that follows, however, a layer of powder adhesive Tn developed to a shape according to an application pattern as a result of an electrophotographic process, for the purpose of applying the powder adhesive Tn onto the sheet P according to a predetermined application pattern, will also be treated as one instance of a “toner image”.

The transfer belt 3a rotates counter-clockwise (arrow v) in the figure. The toner images formed on the process cartridges 7n, 7y, 7m, 7c are primary-transferred from each photosensitive drum 101 to the transfer belt 3a on account of the electric field that is formed between the photosensitive drum 101 and the primary transfer roller 4.

Herein, as illustrated in FIG. 1, the process cartridge 7n that utilizes the powder adhesive Tn is located furthest upstream, in the rotation direction of the transfer belt 3a, from among the four process cartridges. Also, yellow, magenta and cyan process cartridges 7y, 7m, 7c are juxtaposed sequentially from the process cartridge 7n toward the downstream side in the rotation direction of the transfer belt 3a. Therefore, as illustrated in FIG. 3, when four types of toner images are superimposed on each other on the transfer belt 3a, the powder adhesive Tn constitutes a lowermost layer (layer in contact with the transfer belt 3a), with the yellow (Ty), magenta (Tm) and cyan (Tc) printing toners sequentially overlaid on the lowermost layer.

The toner image supported on the transfer belt 3a and having reached the transfer nip 5n is secondary-transferred to a sheet P, having been transported along the main transport path 1m, by an electric field generated between the secondary transfer roller 5 and a secondary transfer inner roller 3b. The top and bottom of the toner layer are flipped at this time. Specifically, on the sheet P having passed through the transfer nip 5n there are overlaid cyan (Tc), magenta (Tm) and yellow (Ty) printing toners, from a lowermost layer (layer in contact with the sheet P), followed by further formation thereon of a layer of the powder adhesive Tn. The powder adhesive Tn layer therefore constitutes the outermost surface in the toner image transferred to the sheet P.

Thereafter, as illustrated in FIG. 1, the sheet P is conveyed to the first fixing unit 6 and is subjected to a heat fixing process. Specifically, the printing toners Ty, Tm, Tc and the powder adhesive Tn melt, and are thereafter fixed, on account of heating and pressing of the toner image on the sheet P as the sheet P passes through the fixing nip 6n; an image fixed to the sheet P is obtained as a result.

Irrespective of whether printing is single-sided or double-sided printing, the sheet P discharged from the apparatus body 10 is nipped between an intermediate roller 34b and a second discharge roller 34c as illustrated in FIG. 4A and FIG. 4B, and is transported by a tray switching guide 13a over a first route R1 or a second route R2.

The first route R1 illustrated in FIG. 4A is a route along which the sheet P that has passed through the first fixing unit 6 is discharged to the first discharge tray 13 by the discharge unit 34, in an ordinary printing mode in which the post-processing unit 30 is not used.

The second route R2 illustrated in FIG. 4B is a route in which the sheet P having passed through the first fixing unit 6 is discharged onto the second discharge tray 35 via the discharge unit 34, the folding device 31 and the second fixing unit 32, in a bonding/printing mode.

An intermediate path 15 is provided between the first fixing unit 6 and the folding device 31 on the second route R2. The intermediate path 15 is a sheet transport path that passes over the top face portion (top surface portion) of the image forming apparatus 1, and extends below the first discharge tray 13 substantially parallelly thereto. The intermediate path 15 and the first discharge tray 13 are tilted upward in the vertical direction, towards the folding device 31, relative to the horizontal direction. Therefore, a below-described guide roller pair (31c, 31d) at the inlet of the folding device 31 is positioned higher up, in the vertical direction, than an outlet of the apparatus body 10 (nip of the intermediate roller 34b and the second discharge roller 34c).

The folding device 31 has four rollers, namely a first guide roller 31c, a second guide roller 31d, a first folding roller 31a and a second folding roller 31b, as well as a draw-in portion 31e. The first guide roller 31c and the second guide roller 31d are a guide roller pair that nips and conveys each sheet P received from a transport path (intermediate path 15 in the present Example) on the upstream side of the folding device 31. The first folding roller 31a and the second folding roller 31b are a folding roller pair that feeds out the sheet P while folding it.

A spacing M (FIG. 1) from the second discharge roller 34c up to the first guide roller 31c in the sheet transport direction along the second route R2 is shorter than a total length L (FIG. 5A) of the sheet P, in the transport direction, prior to the folding process. In other words, the spacing M from the second discharge roller 34c up to the first guide roller 31c determines the lower limit of the length, in the transport direction, of the sheets that can be processed by the post-processing unit 30. Thanks to this configuration, the sheet P is handed over seamlessly from the discharge unit 34 to the guide roller pair.

The folding process performed by the folding device 31 will be described with reference to FIGS. 5A to 5F. When the folding process is executed, the first guide roller 31c and the first folding roller 31a rotate clockwise in the figure, and the second guide roller 31d and the second folding roller 31b rotate counterclockwise in the figure.

First, the front end q of the sheet P fed out from the discharge unit 34 is pulled into the guide roller pair (31c and 31d) as shown in FIG. 5A. As shown in FIG. 5B, the front end q of the sheet P is guided downward by the guide wall 31f, contacted with the first folding roller 31a, pulled between the first folding roller 31a and the second guide roller 31d facing each other, and brought into contact with the wall 31g of the draw-in portion 31e.

As the sheet P is pulled in by the guide roller pair (31c and 31d), the front end q advances to the back of the draw-in portion 31e while sliding in contact with the wall 31g. Eventually, the front end q abuts against an end portion 31h of the draw-in portion 31e as shown in FIG. 5C. The draw-in portion 31e forms a space extending substantially parallel to the intermediate path 15 below the intermediate path 15, and the sheet P is wound into a U-shaped bent state around the second guide roller 31d at the stage shown in FIG. 5C.

Where the sheet P is further pulled in by the guide roller pair (31c and 31d) from the state shown in FIG. 5C, deflection begins to occur in the middle portion r as shown in FIG. 5D. Eventually, as shown in FIG. 4E, the middle portion r comes into contact with the second folding roller 31b, thereby being pulled into the nip portion of the folding roller pair (31a and 31b) by the frictional force received from the second folding roller 31b. Then, as shown in FIG. 5F, the sheet P is discharged with the middle portion r at the front end by the folding roller pair (31a and 31b) in a state of being folded with the middle portion r as a crease.

Here, a depth N (FIG. 5E) of the draw-in portion 31e, that is, a distance from the nip portion of the folding roller pair (31a and 31b) to the end portion 31h of the draw-in portion 31e is set to the length which is half of the total length L of the sheet P. As a result, the folding device 31 can execute a process (middle folding) of folding the sheet P in half at half length. By changing the depth N of the draw-in portion 31e, the position of the crease can be arbitrarily changed.

The folding device 31 described above is an example of folding means, and for example, a folding mechanism that forms a crease by pressing a blade against the sheet P and pushing it into the nip portion of the roller pair may be used. Further, the contents of the folding process are not limited to folding in half, and for example, a folding mechanism that executes Z folding or tri-folding may be used.

Since the folding device 31 is configured of a rotating roller and a fixed draw-in portion 31e, the drive mechanism can be simplified as compared with a folding mechanism using a reciprocating blade. Further, since the folding device 31 may be provided with a draw-in portion 31e having a depth N of half the sheet length in addition to the four rollers, the post-processing unit 30 can be miniaturized.

The sheet P that has passed through the folding device 31 is transported to the second fixing unit 32 as shown in FIG. 4B. The second fixing unit 32 has a heat fixing configuration similar to the first fixing unit 6. That is, the second fixing unit 32 has a heat roller 32b as a heating member and a pressure roller 32a as a pressing member. The heat roller 32b is heated by a heat generating element such as a halogen lamp or a ceramic heater, or by a heating mechanism of induction heating type.

The pressure roller 32a is pressed against the heat roller 32a by an urging member such as a spring and generates a pressurizing force that pressurizes the sheet P passing through the nip portion (bonding nip) of the heat roller 32b and the pressure roller 32a.

The sheet P folded by the folding device 31 is bonded in the folded state by undergoing a bonding process (second heat fixing to the image surface coated with the powder adhesive Tn) by the second fixing unit 32. That is, when the sheet P passes through the bonding nip, the powder adhesive Tn on the sheet P is heated and pressurized in a remelted state, so as to adhere to the facing surface (in the folded state, the surface facing the image surface of the sheet P onto which the toner image of the powder adhesive Tn has been transferred). Then, when the powder adhesive Tn cools and hardens, the image surface and the facing surface of the sheet P are joined (bonded) using the powder adhesive Tn as an adhesive.

As shown in FIG. 4B, the sheet P that has undergone the bonding process by the second fixing unit 32 is discharged to the left side in the figure from the discharge port 32c (second discharge port) provided in the housing 39 of the post-processing unit 30. The sheet is then stored in the second discharge tray 35 (see FIG. 1) provided on the left side surface of the apparatus body 10. This completes the image forming operation when the sheet P is transported along the second route R2.

The joining location of the folded sheet P can be changed by the application pattern of the powder adhesive Tn on the sheet P. FIGS. 7A and 7B exemplify deliverables (output products of an image forming apparatus) having different application patterns of the powder adhesive Tn.

FIG. 7A is an example of a deliverable (half-bonded product) to be opened by a recipient. In the case of a pay slip 52 shown in FIG. 7A, the powder adhesive Tn is applied to the entire circumference 52a of the outer peripheral portion of one side of the sheet P, and the sheet P is bonded in a folded state at the central crease 52b.

FIG. 7B shows a bag (medicine bag 53) as an example of a deliverable (completely bonded deliverable) for applications that do not presuppose the opening. In this case, the powder adhesive Tn is applied to a U-shaped region 53a so that the three sides including the crease 53b of the folded sheet P are joined.

Further, the image forming apparatus 1 can output any of the deliverables illustrated in FIGS. 7A and 7B in a one-stop manner without preparing preprint paper. That is, it is possible to apply the powder adhesive Tn in a predetermined application pattern and output the deliverables subjected to folding process and bonding process in parallel with the operation of recording an image on one side or both sides of the sheet P by using the printing toner.

For example, when the deliverables of FIGS. 7A and 7B are output, one side of the sheet P used as the base paper is on the outside of the deliverable, and the other side is on the inside of the deliverable. Therefore, an image for the outer surface may be formed with the printing toner as an image forming operation on the first surface in double-sided printing, and an image for the inner surface may be formed with the printing toner and the powder adhesive Tn may be applied according to the predetermined application pattern as an image forming operation on the second surface.

The image recorded by the image forming apparatus 1 using the printing toner can include a format (unchanged portion) when using preprint paper and a variable portion such as personal information. Therefore, it is possible to output the deliverable bonded by the bonding process from the base paper such as blank paper which is not the preprinted paper as described above. However, the image forming apparatus 1 can also be used in applications in which the preprinted paper is used as a recording medium and the printing process and bonding process of the variable portion are performed.

### Printing Toner

A known printing toner can be used as the printing toner. Preferred among the foregoing are printing toners that utilize thermoplastic resins as a binder resin. The resin that can be used as the thermoplastic resin is not particularly limited, and resins that are conventionally used in printing toners, for instance polyester resins, vinyl resins, acrylic resins and styrene-acrylic resins can be utilized herein. The printing toner may contain a plurality of these resins.

Yet more preferred among the foregoing is a printing toner containing a styrene acrylic resin as a binder resin. The printing toner may contain a colorant, a magnetic body, a charge control agent, and an external additive, as needed. Besides the binder resin, the printing toner may also contain a polar resin such as a polyester resin.

The printing toner comprises a wax. Examples of the wax that can be used include ester waxes which are esters of an alcohol and an acid; hydrocarbon waxes such as low molecular weight polyethylene, low molecular weight polypropylene, alkylene copolymers, microcrystalline wax, paraffin wax and Fischer-Tropsch waxes; polyester waxes such as crystalline polyester; higher fatty acids; as well as higher aliphatic alcohols.

The wax is expected to elicit an effect mainly as a plasticizer for enhancing the plasticity of the binder resin such as a thermoplastic resin, or to elicit an effect as a release agent during fixing. For instance the plasticizer is preferably an ester wax, a crystalline polyester, a higher fatty acid or a higher aliphatic alcohol, and is more preferably an ester wax. A hydrocarbon wax is preferable as a release agent.

The content of wax in the printing toner is not particularly limited, but is preferably from 1.0 to 25.0 parts by mass, relative to 100 parts by mass of the binder resin. The wax comprised in the printing toner preferably comprises a plasticizer, more preferably comprises an ester wax, and yet more preferably comprises an ester wax and a hydrocarbon wax. The ester wax will be described further on.

The content of the release agent (for instance hydrocarbon wax) in the printing toner is preferably from 0.5 to 10.0 parts by mass, relative to 100 parts by mass of the binder resin. The content of the plasticizer (for instance ester wax) in the printing toner is preferably from 1.0 to 20.0 parts by mass, more preferably 3.0 to 15.0 parts by mass, relative to 100 parts by mass of the binder resin.

The weight-average particle diameter of the printing toner is preferably from 3.0 μm to 12.0 μm, more preferably from 4.0 μm to 8.0 μm. A more preferred range is herein from 6.0 μm to 7.5 μm.

### Powder Adhesive

As the powder adhesive there can be used a powder adhesive containing a thermoplastic resin. The resin that can be used as the thermoplastic resin is not particularly limited. Examples include known thermoplastic resins such as polyester resins, vinyl resins, acrylic resins, styrene acrylic resins, polyethylene, polypropylene, polyolefins, ethylene-vinyl acetate copolymer resins and ethylene-acrylic acid copolymer resins. The powder adhesive may contain a plurality of these resins.

The powder adhesive comprises a wax. Examples of the wax that can be used include ester waxes which are esters of an alcohol and an acid; hydrocarbon waxes such as low molecular weight polyethylene, low molecular weight polypropylene, alkylene copolymers, microcrystalline wax, paraffin wax and Fischer-Tropsch waxes; polyester waxes such as crystalline polyester; higher fatty acids; as well as higher aliphatic alcohols.

The wax is expected to elicit an effect mainly as a plasticizer for enhancing the plasticity of a thermoplastic resin, or to elicit an effect as a release agent during fixing. For instance the plasticizer is preferably an ester wax, a crystalline polyester, a higher fatty acid or a higher aliphatic alcohol, and is more preferably an ester wax. A hydrocarbon wax is preferable as the release agent.

The content of wax in the powder adhesive is not particularly limited, but is preferably from 5.0 to 40.0 parts by mass, and more preferably from 8.0 to 25.0 parts by mass, relative to 100 parts by mass of the binder resin. The wax comprised in the powder adhesive preferably comprises a plasticizer, more preferably comprises an ester wax, and yet more preferably comprises an ester wax and a hydrocarbon wax. The ester wax will be described further on.

The content of the release agent (for instance hydrocarbon wax) in the powder adhesive is preferably from 2.0 to 10.0 parts by mass, more preferably from 2.0 to 7.0 parts by mass and yet more preferably from 2.0 to 5.0 parts by mass, relative to 100 parts by mass of the binder resin. The content of the plasticizer (for instance ester wax) in the powder adhesive is preferably from 10.0 to 30.0 parts by mass, relative to 100 parts by mass of the binder resin.

The content of wax in the powder adhesive must be higher than the content of wax in the printing toner. As a result it becomes possible to suppress offset of the printing toner, improve a sharp melt property, facilitate melting and spreading of the powder adhesive, widen the contact area with the transfer material, and enhance adhesive strength.

Preferably, the content of ester wax in the powder adhesive is higher than the content of ester wax in the printing toner. When the wax content obeys such a relationship, the wax component of adhesive particles can melt faster, during the fixing process, than a matrix (for instance a thermoplastic resin such as a styrene acrylic resin) of the wax component. Accordingly, the wax also acts as a solvent that dissolves the matrix of adhesive particles, thereby improving adhesiveness.

The value of a mass-basis ratio (powder adhesive/printing toner) of the content of wax in the printing toner relative to the content of wax in the powder adhesive is preferably from 1.1 to 5.0, and more preferably from 1.2 to 3.5.

The value of a mass-basis ratio (powder adhesive/printing toner) of the content of plasticizer (for instance ester wax) in the printing toner relative to the content of plasticizer (for instance ester wax) in the powder adhesive is preferably from 1.1 to 5.0, more preferably from 1.2 to 3.0.

The powder adhesive may also contain a colorant. As the colorant there can be used a known colorant such as a black colorant, a yellow colorant, a magenta colorant or a cyan colorant. The content of the colorant in the powder adhesive is preferably 1.0 mass % or less, more preferably 0.1 mass % or less. The powder adhesive may contain a magnetic body, a charge control agent, and an external additive, as needed. Besides the binder, the powder adhesive may also contain a polar resin such as a polyester resin.

The weight-average particle diameter of the powder adhesive is preferably from 5.0 μm to 20.0 μm, more preferably from 5.0 μm to 10.0 μm. In addition to improving adhesive strength and suppressing fogging, scattering of the powder adhesive can be readily suppressed when the weight-average particle diameter of the powder adhesive lies in the above ranges. The printing toner may be used herein doubling as the powder adhesive, so long as the printing toner satisfies adhesive characteristics.

### Plasticizer

Preferably, the powder adhesive Tn and the wax in the printing toner contain a crystalline plasticizer for the purpose of enhancing the sharp melt property. More preferably, the wax includes an ester wax. The ester wax is not particularly limited, and the following known products that are utilized in common toners can be used herein.

Specific examples include esters of a monohydric alcohol and an aliphatic carboxylic acid and esters of a monovalent carboxylic acid and an aliphatic alcohol, such as behenyl behenate, stearyl stearate and palmityl palmitate; esters of a dihydric alcohol and an aliphatic carboxylic acid or esters of a divalent carboxylic acid and an aliphatic alcohol, such as ethylene glycol distearate, dibehenyl sebacate, hexanediol dibehenate; esters of a trihydric alcohol and an aliphatic carboxylic acid and esters of a trivalent carboxylic acid and an aliphatic alcohol, such as glycerin tribehenate; esters of a tetravalent alcohol and an aliphatic carboxylic acid and esters of a tetravalent carboxylic acid and an aliphatic alcohol, such as pentaerythritol tetrastearate and pentaerythritol tetrapalmitate; esters of a hexavalent alcohol and an aliphatic carboxylic acid and esters of a hexavalent carboxylic acid and an aliphatic alcohol, such as dipentaerythritol hexastearate and dipentaerythritol hexapalmitate; esters of polyhydric alcohols and aliphatic carboxylic acids and esters of polyvalent carboxylic acids and aliphatic alcohols, such as polyglycerol behenate; as well as natural ester waxes such a carnauba wax and rice wax. The foregoing may be used singly or concomitantly.

Preferably among the foregoing, the ester wax comprised at least one selected from the group consisting of the ester wax represented by Formula (1) below and the ester wax represented by the Formula (2) below.

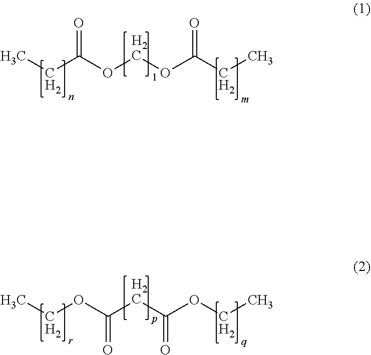

In Formula (1) and Formula (2), 1 and p each represent a positive integer from 1 to 12 (preferably from 2 to 6); and n, m, r and q each independently represents a positive integer from 11 to 25 (preferably from 16 to 22).

The ester wax is more preferably a compound represented by Formula (3) below. More preferably, the wax comprised in the powder adhesive comprises in turn an ester wax represented by Formula (3) below. Particularly preferably, the ester wax comprises an ethylene glycol distearate.

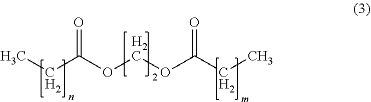

In Formula (3), n and m each independently represents a positive integer from 16 to 22.

### Production Example of a Powder Adhesive

Styrene 75.0 parts
n-butyl acrylate 25.0 parts
Polyester resin 4.0 parts

(Polyester resin having a weight-average molecular weight (Mw) of 20000, a glass transition temperature (Tg) of 75° C., and an acid value of 8.2 mgKOH/g; condensation product of terephthalic acid: propylene oxide 2-mole adduct of bisphenol A: ethylene glycol=50:40:10 (molar ratio))
Ethylene glycol distearate 15.0 parts

(Ester wax resulting from esterifying ethylene glycol and stearic acid)
Hydrocarbon wax (HNP-9, by Nippon Seiro Co., Ltd.) 2.0 parts
Divinylbenzene 0.5 parts

A mixture resulting from mixing the above materials was kept at 60° C., and was stirred at 500 rpm using T. K. Homomixer (by Tokushu Kika Kogyo Co., Ltd.), to elicit uniform dissolution and prepare a polymerizable monomer composition.

Separately, 850.0 parts of a 0.10 mol/L aqueous solution of Na₃PO₄ and 8.0 parts of 10% hydrochloric acid were added into a vessel provided with a high-speed stirring device CLEARMIX (by M Technique Co., Ltd.), the revolutions were adjusted to 15000 rpm, and the temperature was raised to 70° C. Then 127.5 parts of a 1.0 mol/L aqueous solution of CaCl₂) were added thereto, to prepare an aqueous medium that contained a calcium phosphate compound.

The above polymerizable monomer composition was inputted into the aqueous medium, followed by addition of 7.0 parts of t-butyl peroxypivalate as a polymerization initiator, and granulation for 10 minutes while keeping revolutions at 15000 rpm. Thereafter, the stirrer was changed from a high-speed stirrer to a propeller stirring blade, and the reaction was conducted at 70° C. for 5 hours while under reflux, after which the liquid temperature was adjusted to 85° C., and the reaction was left to proceed for a further 2 hours.

Once the polymerization reaction was over, the obtained slurry was cooled, and hydrochloric acid was further added to the slurry, to adjust the pH to 1.4, whereupon the resulting mixture was stirred for 1 hour, to thereby dissolve a calcium phosphate salt. Thereafter, the slurry was washed with water in an amount of thrice the amount of the slurry, with filtration and drying, followed by classifying, to yield powder adhesive particles.

Thereafter, 2.0 parts of silica fine particles (number-average particle diameter of primary particles: 10 nm; BET specific surface area: 170 m²/g) having undergone a hydrophobic treatment using dimethyl silicone oil (20 mass %) were added, as an external additive, to 100.0 parts of the powder adhesive particles, and the whole was mixed using a Mitsui Henschel mixer (by Mitsui Miike Engineering Corporation), at 3000 rpm for 15 minutes, to yield a powder adhesive. The weight-average particle diameter of the obtained powder adhesive was 8.0 μm.

### Production Example of a Printing Toner

Styrene 60.0 parts
Colorant 6.5 parts

(C. I. Pigment Blue 15:3, by Dainichiseika Color & Chemicals Mfg. Co., Ltd.)

The above materials were placed in an Attritor (by Mitsui Miike Engineering Corporation), and were dispersed at 220 rpm for 5 hours, using zirconia particles having a diameter of 1.7 mm, to yield a pigment dispersion.
Styrene 15.0 parts
n-butyl acrylate 25.0 parts
Polyester resin 4.0 parts

(Polyester resin having a weight-average molecular weight (Mw) of 20000, a glass transition temperature (Tg) of 75° C., and an acid value of 8.2 mgKOH/g; condensation product of terephthalic acid: propylene oxide 2-mole adduct of bisphenol A: ethylene glycol=50:40:10 (molar ratio))
Ethylene glycol distearate 10.0 parts

(Ester wax made by esterifying ethylene glycol and stearic acid)
Hydrocarbon wax (HNP-9, by Nippon Seiro Co., Ltd.) 2.0 parts
Divinylbenzene 0.5 parts

The above materials were mixed and added to the pigment dispersion. The obtained mixture was kept at 60° C., and was stirred at 500 rpm using T. K. Homomixer (by Tokushu Kika Kogyo Co., Ltd.), to elicit uniform dissolution and prepare a polymerizable monomer composition.

Separately, 850.0 parts of a 0.10 mol/L aqueous solution of Na₃PO₄ and 8.0 parts of 10% hydrochloric acid were added into a vessel provided with a high-speed stirring device CLEARMIX (by M Technique Co., Ltd.), the revolutions were adjusted to 15000 rpm, and the temperature was raised to 70° C. Then 127.5 parts of a 1.0 mol/L aqueous solution of CaCl₂) were added thereto, to prepare an aqueous medium that contained a calcium phosphate compound.

The above polymerizable monomer composition was inputted into the aqueous medium, followed by addition of 7.0 parts of t-butyl peroxypivalate as a polymerization initiator, and granulation for 10 minutes while keeping revolutions at 15000 rpm. Thereafter, the stirrer was changed from a high-speed stirrer to a propeller stirring blade, and the reaction was conducted at 70° C. for 5 hours while under reflux, after which the liquid temperature was adjusted to 85° C., and the reaction was left to proceed for a further 2 hours.

Once the polymerization reaction was over, the obtained slurry was cooled, and hydrochloric acid was further added to the slurry, to adjust the pH to 1.4, whereupon the resulting mixture was stirred for 1 hour, to thereby dissolve a calcium phosphate salt. Thereafter, the slurry was washed with water in an amount of thrice the amount of the slurry, with filtration and drying, followed by classifying, to yield a toner particle.

Thereafter, 2.0 parts of silica fine particles (number-average particle diameter of primary particles: 10 nm; BET specific surface area: 170 m²/g) having undergone a hydrophobic treatment using dimethyl silicone oil (20 mass %) were added, as an external additive, to 100.0 parts of the toner particle, and the whole was mixed using a Mitsui Henschel mixer (by Mitsui Miike Engineering Corporation), at 3000 rpm for 15 minutes, to yield a toner.

The weight-average particle diameter of the obtained toner was 6.5 μm.

### Method for Measuring the Weight-Average Particle Diameter

The weight-average particle diameter of the printing toner and the powder adhesive (measurement sample) is determined proceeding as follows. The measurement instrument used is a “Coulter Counter Multisizer 3” (registered trademark, Beckman Coulter, Inc.), a precision particle size distribution measurement instrument operating on the pore electrical resistance method and equipped with a 100 μm aperture tube. The measurement conditions are set and the measurement data are analyzed using the accompanying dedicated software, i.e., “Beckman Coulter Multisizer 3 Version 3.51” (Beckman Coulter, Inc.). The measurements are carried out in 25,000 channels for the number of effective measurement channels.

The aqueous electrolyte solution used for the measurements is prepared by dissolving special-grade sodium chloride in deionized water to provide a concentration of 1 mass % and, for example, “ISOTON II” (Beckman Coulter, Inc.) can be used.

The dedicated software is configured as follows prior to the execution of measurement and analysis. In the “modify the standard operating method (SOM)” screen in the dedicated software, the total count number in the control mode is set to 50,000 particles; the number of measurements is set to 1 time; and the Kd value is set to the value obtained using “standard particle 10.0 μm” (Beckman Coulter, Inc.). The threshold value and noise level are automatically set by pressing the “threshold value/noise level measurement button”. In addition, the current is set to 1,600 μA; the gain is set to 2; the electrolyte solution is set to ISOTON II; and a check is entered for the “post-measurement aperture tube flush”.

In the “setting conversion from pulses to particle diameter” screen of the dedicated software, the bin interval is set to logarithmic particle diameter; the particle diameter bin is set to 256 particle diameter bins; and the particle diameter range is set to 2 μm to 60 μm.

The specific measurement procedure is as follows.
(1) 200 mL of the aqueous electrolyte solution is introduced into a 250 mL roundbottom glass beaker intended for use with the Multisizer 3 and this is placed in the sample stand and counterclockwise stirring with the stirrer rod is carried out at 24 rps. Contamination and air bubbles within the aperture tube are preliminarily removed by the “aperture tube flush” function of the dedicated software.
(2) 30 mL of the aqueous electrolyte solution is introduced into a 100 mL flatbottom glass beaker. To this is added as dispersing agent 0.3 mL of a dilution prepared by the three-fold (mass) dilution with deionized water of “Contaminon N” (a 10 mass % aqueous solution of a neutral pH 7 detergent for cleaning precision measurement instrumentation, comprising a nonionic surfactant, anionic surfactant, and organic builder, from Wako Pure Chemical Industries, Ltd.).
(3) An “Ultrasonic Dispersion System Tetora 150” (Nikkaki Bios Co., Ltd.) is prepared; this is an ultrasound disperser with an electrical output of 120 W and is equipped with two oscillators (oscillation frequency=50 kHz) disposed such that the phases are displaced by 180°. 3.3 L of deionized water is introduced into the water tank of the ultrasound disperser and 2 mL of Contaminon N is added to this water tank.
(4) The beaker described in (2) is set into the beaker holder opening on the ultrasound disperser and the ultrasound disperser is started. The vertical position of the beaker is adjusted in such a manner that the resonance condition of the surface of the aqueous electrolyte solution within the beaker is at a maximum.
(5) While the aqueous electrolyte solution within the beaker set up according to (4) is being irradiated with ultrasound, 10 mg of the measurement sample is added to the aqueous electrolyte solution in small aliquots and dispersion is carried out. The ultrasound dispersion treatment is continued for an additional 60 seconds. The water temperature in the water tank is controlled as appropriate during ultrasound dispersion to be from 10° C. to 40° C.
(6) Using a pipette, the aqueous electrolyte solution prepared in (5) and containing dispersed toner or a dispersed powder adhesive, is dripped into the roundbottom beaker set in the sample stand as described in (1) with adjustment to provide a measurement concentration of 5%. Measurement is then performed until the number of measured particles reaches 50,000.
(7) The measurement data is analyzed by the dedicated software provided with the instrument and the weight-average particle diameter (D4) is calculated. When set to graph/volume % with the dedicated software, the “average diameter” on the “analysis/volumetric statistical value (arithmetic average)” screen is the weight-average particle diameter (D4). Hereafter, the weight-average particle diameter described as the particle diameter.

### Adhesive Strength Control by the Powder Adhesive

The strength of a bonded portion, i.e. the adhesive strength, upon obtention of for instance a bag-shaped deliverable through bonding the powder adhesive using a bonding means 32, is measured as follows.

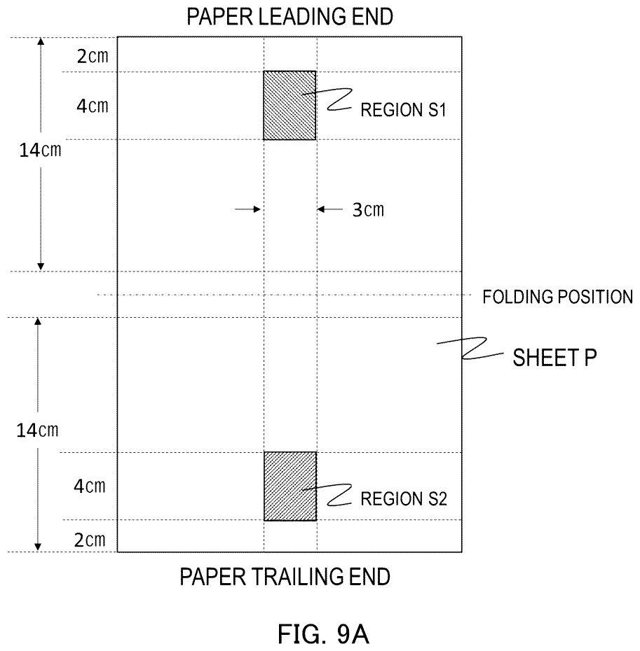

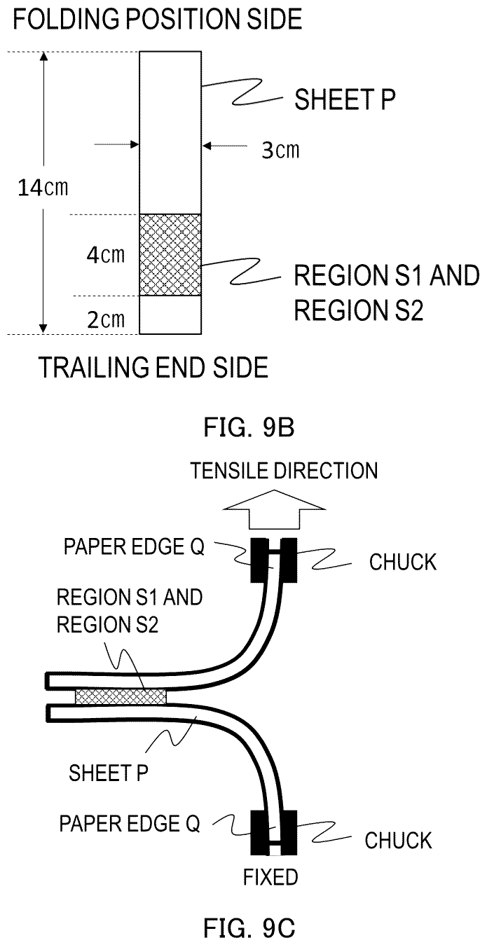

FIG. 9A illustrates the specifications of a sample used for adhesive strength measurement, FIG. 9B is a diagram of the completed sample, and FIG. 9C is a diagram illustrating a method for measuring adhesive strength. A sample is obtained in the manner below, as per FIG. 9A. Herein GF-C081 sold by Canon Marketing Japan Inc. is used as the sheet P.

The powder adhesive Tn is printed longitudinally at the center of the sheet P, over a width of 3 cm, while extending over a 4 cm stretch from a position 2 cm off the leading end of the sheet P, in the paper feeding direction, to form a hatched bonding region S1. Next, the powder adhesive Tn is printed longitudinally at the center of the sheet P, over a width of 3 cm, while extending over a 4 cm stretch from a position 2 cm off the trailing end of the sheet P, in the paper feeding direction, to form a hatched bonding region S2. The resulting sheet P is folded together using a folding means 31 depicted in FIG. 1, followed by bonding by the bonding means 32. As illustrated in FIG. 9B, the resulting sheet P is then trimmed so that the sheet P is 3 cm wide and has a total length of 14 cm from the leading end in the feeding direction of the bonded paper.

Then the paper edges Q of the long non-bonded portion of the sample are supported on respective chucks, as illustrated in FIG. 9C. A tensile test is performed thereupon at a tensile rate of 50 mm/min, using RTG-1225 Tensilon Universal Tester, not shown, by A&D Company, Limited, to obtain a stress-strain curve.

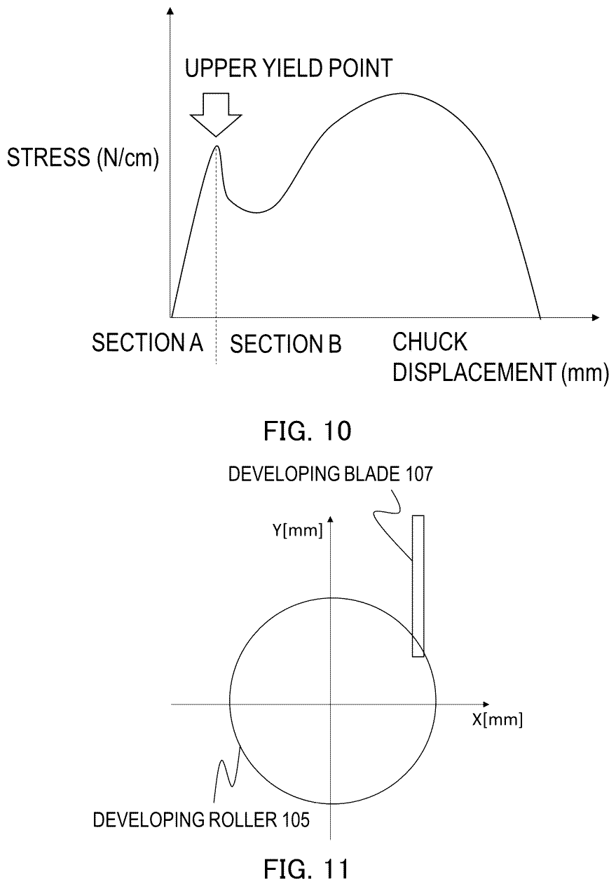

FIG. 10 is an example of a stress-strain curve. The horizontal axis denotes chuck displacement and the vertical axis denotes tensile stress per unit sample width. Herein Section A denotes a section from a displacement of 0 mm up to an upper yield point, and Section B denotes the section past the upper yield point. Section A is an elastic deformation region at which peeling of the bonding region does not occur. Accordingly, the sample retains its original shape once pulling is discontinued. By contrast, Section B is a plastic deformation region at which there occurs peeling of the bonding region or tearing of the paper, as described below. In the present disclosure, adhesive strength is defined hereafter as stress per unit width at the upper yield point. Thus, the bonded portion begins to peel off as the sample continues to be pulled past the upper yield point. This signifies that the bottom of the bag, as a deliverable, begins to fall out.

### Method for Setting a Laying Amount, Per Unit Area, of Powder Applied on the Sheet P

A method for setting the laying amount per unit area of powder applied on the sheet P (hereafter referred to as M/S) will be explained next. Herein M/S is determined by the laying amount of the powder per unit area on the developing roller 105 (hereafter referred to as M/Sd), a ratio of the peripheral speeds of the photosensitive drum 101 and of the developing roller 105, a transfer efficiency (1) from the photosensitive drum 101 to the transfer unit 3, and a transfer efficiency (2) from the transfer unit 3 to the sheet P.

A method for determining M/Sd will be illustrated first with reference to FIG. 11. Herein M/Sd was set on the basis of the positional relationship between the developing blade 107 and the developing roller 105. FIG. 11 is a diagram illustrating the position of the end of the developing blade 107 relative to the rotation center of the developing roller 105. The pressure with which the developing blade 107 is in contact with the developing roller 105 is mainly controlled in the X-axis. The uptake amount of the powders Tn, Ty, Tm, Tc is controlled in the Y axis. Further, M/Sd is determined by which one from among X and Y (hereafter referred to as X value and Y value) the tip position of the developing blade 107 is set at. Table 1 sets out the relationship between a setting (X value, Y value) of the developing blade 107 and M/Sd, in respective developing apparatuses. The contact pressure of the developing blade 107 against the developing roller 105 at this time was 30 N/cm.

TABLE 1
Relationship between setting of developing blade
107 and M/Sd in respective developing apparatus

| | X value | Y value | M/Sd |
|---|---|---|---|
| Developing apparatus for printing | 5.0 | 1.0 | 0.35 |
| Developing apparatus for powder bonding | 5.0 | 0.6 | 0.60 |

In the adhesive image forming section that uses the powder adhesive Tn, M/Sd can be increased by reducing the Y value and thus increasing the uptake, as compared with the print image forming section that utilizes the printing toners Ty, Tm, Tc. That is because M/Stotal (amount of powder adhesive present in the bonding region between recording media) necessary for obtaining sufficient adhesive strength as derived from the powder adhesive is larger than the laying amount of printing toner per unit area of the sheet P as required for visual recognition of the printing toner image (hereafter M/Sp). Specifically, visibility of the printing toner could be sufficiently ensured for M/Sp of 0.45. The M/Stotal required in order to obtain sufficient adhesive strength will be described further on.

The ratio between the peripheral speeds of the photosensitive drum 101 and the developing roller 105 (developing roller 105/photosensitive drum 101) was 150%, the transfer efficiency (1) from the photosensitive drum 101 to the transfer unit 3 was 97%, and the transfer efficiency (2) from the transfer unit 3 to the sheet P was 95%.

### Fogging Evaluation Method

A method for evaluating fogging will be explained next. The powder adhesive Tn used in the present Example is transparent, and accordingly quantification using a conventional reflection densitometer cannot be resorted to. An area ratio of the powder calculated from observation photographs on the photosensitive drum 101 is taken herein as an evaluation index. Specifically, printing of a solid white image in the image forming apparatus 1 is discontinued, and thereupon the solid white image formed on the photosensitive drum 101, in a region after passage through the developing roller 105 and prior to contact with the transfer unit 3, is captured photographically.

Then a VK-X200 shape measurement laser microscope by Keyence Corporation is used to capture images at magnifications of 20×. The captured images are analyzed using imageJ software by Wayne Rasband. A photograph is captured, is binarized, and a histogram thereof is displayed. A powder adhesive area ratio (%) is defined herein as the ratio (%) of the surface area of the powder adhesive relative to the total surface area. Therefore, the area ratio of the powder adhesive increases when fogging occurs.

The criteria for determining fogging involved ratings based on the area ratio of the powder adhesive, as set out in the “Fogging determination criteria” of Table 2.

TABLE 2
Fogging determination criteria

| Powder adhesive area ratio | Ranking |
|---|---|
| 0% ≤ Powder adhesive area ratio < 5% | A |
| 5% ≤ Powder adhesive area ratio < 10% | B |
| 10% ≤ Powder adhesive area ratio < 15% | C |
| 15% ≤ Powder adhesive area ratio < 20% | D |

### Comparative Examples

The main configuration is identical to that of Example 1. In Comparative example 1 there was modified the M/Sd of printing toners Ty, Tm, Tc. In Comparative examples 2 to 5 there was modified the particle diameter (weight-average particle diameter) of the printing toners Ty, Tm, Tc. In Comparative examples 4 and 5, also the external addition formulation was modified. The contents of ester wax and hydrocarbon wax in Comparative examples 1 to 5 are identical to those of the printing toner.

Silica was externally added in Example 1 and Comparative examples 1 to 5, from the viewpoint of ensuring flowability. From the viewpoint of improving transferability, large silica with an outer diameter several times that of Example 1 was externally added in Comparative examples 4 and 5, instead of the silica used in Example 1. The particle diameter of silica (number-average particle diameter of primary particles) was 10 nm, and the particle diameter of large silica was 40 nm. The external addition amounts of silica and of large silica were set to 1.5 parts with respect to 100 parts of toner particle.

“Table 3. List of physical properties of the powders” summarizes the amount of plasticizer, particle diameter, M/Sd and external addition or non-addition of large silica, in the printing toners Ty, Tm, Tc, the powder adhesive Tn and the comparative examples. The Y value of the comparative examples was adjusted to the respective values of M/Sd given in the table.

TABLE 3
List of physical properties of respective powders

| | Plasticizer | Particle | | External |
|---|---|---|---|---|
| | (ester wax) | diameter | | addition of |
| | amount | (μm) | M/Sd | large silica |
| Example 1 Printing | 10.0 parts | 6.5 | 0.35 | No |
| toner | | | | |
| Example 1 Powder | 15.0 parts | 8.0 | 0.60 | No |
| adhesive Tn | | | | |
| Comparative example 1 | 10.0 parts | 6.5 | 0.60 | No |
| Powder adhesive | | | | |
| Comparative example 2 | 10.0 parts | 25.0 | 0.60 | No |
| Powder adhesive | | | | |
| Comparative example 3 | 10.0 parts | 20.0 | 0.60 | No |
| Powder adhesive | | | | |
| Comparative example 4 | 10.0 parts | 15.0 | 0.60 | Yes |
| Powder adhesive | | | | |
| Comparative example 5 | 10.0 parts | 10.0 | 0.60 | Yes |
| Powder adhesive | | | | |

### Comparison Between Example 1 and Comparative Examples

Adhesive strength, fogging, and scattering were compared, in accordance with the above methods, for the configurations of Example 1 and Comparative examples 1 to 5. “Table 4. List of comparison results between Example 1 and comparative examples” is a list of the results of a comparison between Example 1 and respective comparative examples. The adhesive strength Max given in Table 4 was a maximum value upon modification of M/Stotal.

TABLE 4
List of comparison results between
Example 1 and comparative examples

| | Adhesive | | |
|---|---|---|---|
| | strength | | |
| | Max (N/cm) | Fogging | Scattering |
| Example 1 Powder | 1.0 | B | Did not occur |
| adhesive Tn | | | |
| Comparative example 1 | 0.7 | C | Did not occur |
| Powder adhesive | | | |
| Comparative example 2 | 0.7 | B | Occurred |
| Powder adhesive | | | |
| Comparative example 3 | 0.7 | B | Did not occur |
| Powder adhesive | | | |
| Comparative example 4 | 0.7 | B | Occurred |
| Powder adhesive | | | |
| Comparative example 5 | 0.7 | B | Did not occur |
| Powder adhesive | | | |

### Adhesive Strength

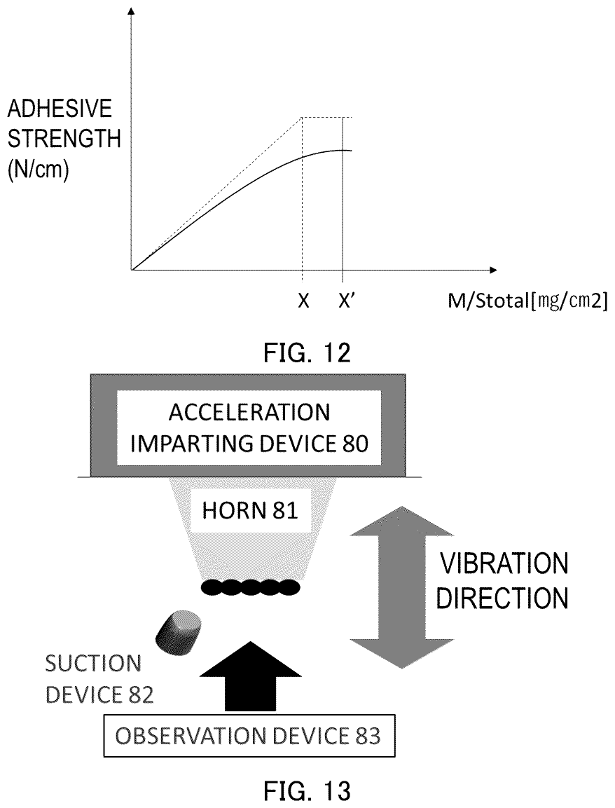

Adhesive strength in Example 1 was higher than that in Comparative examples 1 to 5. FIG. 12 illustrates a comparison of M/Stotal and adhesive strength. The vertical axis is adhesive strength per unit length [N/cm] in the longitudinal direction, and the horizontal axis is M/Stotal [mg/cm²]. The dashed line represents adhesive strength in Example 1, and the solid line represents adhesive strength in Comparative examples 1 to 5. Adhesive strength increases with increasing contact area between the adhesive and the sheet P. To expand the contact area there may be increased M/S; for a given same M/S, however, the contact area can also be increased for instance through greater melting and spreading of the powder adhesive Tn.

However, the printing toners Ty, Tm, Tc may suffer offset if excessive heat is imparted to elicit good melting. Further, the M/S of the powder adhesive Tn is larger than that of the printing toners Ty, Tm, Tc, and accordingly printing toners Ty, Tm, Tc suffer offset when the amount of heat is simply increased so as to elicit good melting and spread of the powder adhesive Tn. The fixation temperature at the time of secondary fixing by the bonding means 32 was set to 200° C., from the viewpoint of suppressing offset of the printing toners Ty, Tm, Tc.

Diligent research revealed that by increasing the plasticizer amount of the powder adhesive Tn as compared with that of the printing toners Ty, Tm, Tc it becomes possible to enhance the sharp melt property of the powder adhesive Tn and to increase the adhesive strength and the contact area of the powder adhesive Tn with the sheet P as compared with printing toners, while suppressing offset of the printing toners.

In Example 1 the amount of wax of the printing toners Ty, Tm, Tc is larger than that in Comparative examples 1 to 5. As a result, as illustrated in FIG. 12, adhesive strength was improved to a greater degree, with respect to changes in M/Stotal, than in Comparative examples 1 to 5. It is deemed that the underlying reason for this is that by increasing the amount of wax, the powder adhesive Tn can be melted quickly, so that as a result, the contact area at the interface between region 1 and region 2 illustrated in FIG. 9C can be increased efficiently.

The adhesive strength becomes constant in a region of M/Stotal≥X on account of tearing of the sheet P. Although adhesive strength increases along with M/Stotal, the adhesive strength remains nevertheless constant herein since the upper yield point illustrated in FIG. 10 depends on the strength of the sheet P.

In Comparative examples 1 to 5, by contrast, the amount of wax was the same as that in the printing toners Ty, Tm, Tc, and hence the contact area could not be sufficiently expanded, and sufficient adhesive strength, as that in Example 1, could not be obtained. In a region at which M/Stotal>X′, the amount of heat obtained from the bonding means 32 did not allow for sufficient melting of the powder adhesive Tn, the increase in contact area was smaller, and adhesive strength virtually did not increase.

### Fogging

Fogging is a phenomenon whereby toner having low triboelectric charge (charge amount) migrates to a dark potential area on the photosensitive drum 101. For instance in one-component development systems, toner ordinarily acquires triboelectric charge as a result of triboelectric charging from the developing roller 105 or the developing blade 107. The magnitude of the triboelectric charge is accordingly influenced by the number of opportunities for rubbing against the developing roller 105 or the developing blade 107.

In the case of a thin layer having a particle diameter of 6.5 μm and M/Sd of about 0.35, as in the printing toners Ty, Tm, Tc in the present Example, the number of toner layers in a regulating section is about 1.5 layers (layer having a thickness of about 1.5 times the toner particle diameter). In consequence the toner can rub satisfactorily against the developing roller 105 or the developing blade 107 well, and high triboelectric charge can be maintained. Fogging can be readily suppressed as a result.

In Comparative example 1, by contrast, the particle diameter is identical to that of the printing toners Ty, Tm, Tc; in order to achieve adhesive strength, thus, M/Sd is made higher for instance through adjustment of the Y value of the developing blade 107. By doing so the number of powder layers in the regulating section of the developing blade 107 increases, and interlayer toner arises that cannot rub against the developing roller 105 or the developing blade 107. Sufficient triboelectricity cannot be imparted as a result, which translates into the occurrence of fogging.

The inventors have found that fogging can be suppressed, even for a high M/Sd, by increasing the particle diameter of the powder adhesive. When the particle diameter is large, the number of powder layers can be reduced, for a same M/Sd, and thus triboelectric charge is imparted readily. In consequence, if the effect derived from reducing the number of layers overcomes a given increase in M/Sd, then opportunities for rubbing against the developing roller 105 or the developing blade 107 can be maintained, and sufficient triboelectric charge can be imparted. Fogging can be suppressed as a result.

Specifically, fogging can be suppressed while achieving M/Stotal such that sufficient adhesive strength is obtained, when Formula (4) below is satisfied where M/SdA is the M/Sd of the printing toner, M/SdB is the M/Sd of the powder adhesive, Wt is the volume of one particle of the printing toner, calculated from the weight-average particle diameter thereof, and Wn is the volume of one particle of the powder adhesive, calculated from the weight-average particle diameter thereof.

$$( M / SdB ) / ( M / SdA ) < Wn / Wt \qquad ( 4 )$$

That is because the number of powder layers in the regulating section can be suppressed, sufficient rubbing opportunities can be secured, and fogging can be suppressed, by eliciting an increase in M/Sd through an increase in volume.

In Example 1 fogging was good, as described above. In Comparative example 1, by contrast the particle diameter was the same as that of the printing toners Ty, Tm, Tc, and accordingly the number of powder layers in the regulating section of the developing blade 107 increased, rubbing opportunities decreased, and fogging occurred.

Preferably, the laying amount (M/SdB) [mg/cm²] of powder adhesive per unit area on the second developer bearing member (second developing roller) for developing the electrostatic latent image that is formed on the second image bearing member (second photosensitive member), in the adhesive image forming section, is larger than the laying amount (M/SdA) [mg/cm²] of printing toner per unit area on the first developer bearing member (first developing roller) for developing the electrostatic latent image that is formed on the first image bearing member (first photosensitive member) in the print image forming section.

The value of a ratio of the laying amount (M/SdB) of powder adhesive per unit area on the second developing roller relative to the laying amount (M/SdA) of printing toner per unit area on the first developing roller (M/SdB)/(M/SdA) lies preferably in the range from 1.05 to 3.00, and more preferably in the range from 1.09 to 2.70.

The laying amount (M/SdB) [mg/cm²] of powder adhesive per unit area on the second developing roller is not particularly limited, but is preferably from 0.55 to 0.80, more preferably from 0.60 to 0.80.

The laying amount (M/SdA) [mg/cm²] of printing toner per unit area on the first developing roller is not particularly limited, but is preferably from 0.30 to 0.55.

### Scattering

Scattering occurs when from among the force with which powder adheres to for instance to the photosensitive drum 101 or the transfer unit 3 (hereafter attachment force) and the force with which the powder is peeled off the foregoing (hereafter peel-off force), it is the peel-off force that is the larger force. Examples of the peel-off force include centrifugal forces that are sustained during driving, as well as airflow-derived air resistance. Examples of attachment forces include van der Waals forces and reflection forces. When the weight-average particle diameter of the powder adhesive Tn is made smaller, both centrifugal forces and air resistance are reduced, which in consequence allows readily suppressing scattering.

The evaluation of scattering in Table 4 was determined on the basis of the occurrence or absence of scattering inside of the image forming apparatus and/or on the outer peripheral surface of the process cartridge at the time of printing of 10000 prints of a longitudinal-band image having a width of 5 mm, in an environment at 23° C. and 50% Rh.

In terms of enhancing adhesive strength, large silica that improves transfer efficiency may be externally added, for the purpose of increasing M/Stotal. Large silica reduces herein the contact area between the powder adhesive Tn and the photosensitive drum 101 and/or the transfer unit 3, thereby reducing attachment forces and improving transfer efficiency. When by contrast the contact area is reduced, van der Waals forces are smaller, and the occurrence of scattering becomes a concern. From the viewpoint of suppressing scattering, therefore, the weight-average particle diameter of the powder adhesive Tn is preferably set to be about 5 to 10 μm, in the case of external addition of large silica. Alternatively, it is preferable not to externally add any large silica.

For instance the number-average particle diameter of the primary particles of silica is preferably from 5 nm to less than 30 nm, more preferably from 7 to 20 nm, and yet more preferably from 7 to 15 nm. The content of silica is preferably from 0.1 to 10.0 parts by mass, more preferably from 0.5 to 5.0 parts by mass, and yet more preferably from 1.0 to 3.0 parts by mass, relative to 100 parts by mass of the toner particle.

For instance the number-average particle diameter of primary particles of large silica is preferably from 30 nm to 200 nm, more preferably from 35 to 100 nm, and yet more preferably from 35 to 50 nm. The content of large silica is preferably from 1.0 to 2.0 parts by mass, more preferably from 1.0 to 1.5 parts by mass, relative to 100 parts by mass of the toner particle. Blotting derived from insufficient triboelectric charge can be suppressed when the content of large silica is 1.0 part by mass or more. Defective fixing can be suppressed when the content of large silica is 1.5 parts by mass or less.

A method for measuring attachment forces will be explained with reference to FIG. 13. FIG. 13 illustrates a schematic diagram of a device for measuring attachment forces. Firstly, a powder is caused to adhere to the tip of a horn 81, static electricity is removed using an ionizer, and thereafter the horn 81 is set in an acceleration imparting device 80. As indicated by the arrow denoting the direction of vibration, the scattered powder is sucked by a suction device 82 while the acceleration imparting device 80 imparts acceleration to the horn 81 in the vertical direction in the figure. Observation images of toner adhered to the horn 81 before and after application of acceleration are acquired by an observation device 83, and the number and the particle diameter of scattered toner particles are calculated by an analysis device, not shown. Thereupon an attachment force is calculated on the basis of the imparted acceleration and the particle diameter of the scattered powder.

Specifically, the attachment force is calculated according to the expression below.

$$Attachment force F [ n N ] = a \times m$$

where a: acceleration upon toner scattering, and m: mass of toner (resulting from multiplying volume, calculated from the particle diameter, by specific gravity (set to 1.0 in the present Example))

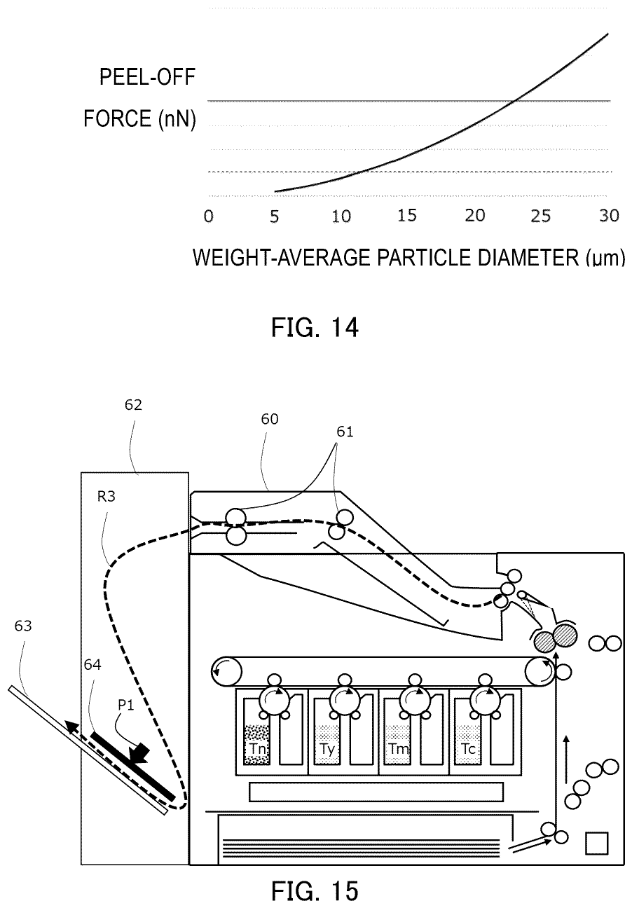

FIG. 14 is a diagram illustrating a relationship between the weight-average particle diameter of the powder adhesive Tn and a peel-off force. The vertical axis represents the force exerted on the toner [nN], and the horizontal axis represents the weight-average particle diameter [μm]. The peel-off force obtained on account of the occurrence of scattering in the present Example is denoted by a thick solid curve. The horizontal solid line denotes a threshold value for the occurrence of scattering, upon external addition of silica, and the thick horizontal dashed line denotes a threshold value for the occurrence of scattering, upon external addition of large silica.

Scattering occurs when the peel-off force is larger than a threshold value for the occurrence of scattering. The threshold value of scattering occurrence is determined by the magnitude of the attachment force of the powder adhesive. The low threshold value for external addition of large silica derives from the low attachment force, as described above. FIG. 14 reveals that in Comparative examples 2 and 4, scattering occurred due to the fact that the peel-off force exceeded the scattering threshold value.

From the viewpoint of scattering, and in view of the attachment force in Example 1 and Comparative examples 1 to 3, preferably the weight-average particle diameter of the powder adhesive Tn ranges from 5 μm to 20 μm.

Yet more preferably, from the viewpoint of improving transferability, the weight-average particle diameter of the powder adhesive Tn is more preferably from 5 μm to 10 μm, for the purpose of suppressing scattering even in a state where the attachment force has decreased, through external addition of large silica.

From the above it follows that scattering could be suppressed, in Example 1 and Comparative examples 1 and 3, thanks to the external addition formulation and by virtue of the fact that the weight-average particle diameter was from 5 to 20 μm. Although large silica was externally added in Comparative example 5, scattering could be suppressed because the weight-average particle diameter was from 5 to 10 μm. In Comparative examples 2 and 4, by contrast, the attachment force was smaller than the peel-off force, and hence scattering occurred.

From the above it follows that by making the amount of wax in the powder adhesive larger than the amount of wax in the printing toner it becomes possible to improve adhesive strength while suppressing offset in the printing toners Ty, Tm, Tc.

More preferably, the content of plasticizer (for instance ester wax) in the powder adhesive is larger than the content of plasticizer (for instance ester wax) in the printing toner. More preferably, the weight-average particle diameter of the powder adhesive is from 5 to 20 μm. More preferably, the weight-average particle diameter of the powder adhesive is larger than the weight-average particle diameter of the printing toner. As a result of the above it becomes possible to further enhance adhesive strength while further suppressing fogging and scattering.

### Example 2

Unless otherwise noted, the configuration in Example 2 is identical to that in Example 1.

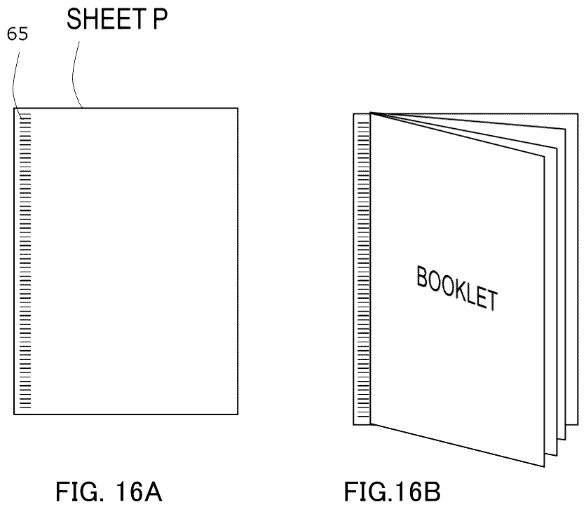

Example 2 differs as regards the deliverable that is obtained, and also in the features of a bonding process. A relevant explanation follows with reference to FIG. 15, FIG. 16A and FIG. 16B. FIG. 15 is a schematic diagram of an image forming apparatus according to Example 2. In Example 2 a booklet can be created in a post-processing step.

An arrow R3 denoted by a dotted line is a transport path of the sheet P. After having been discharged from the image forming apparatus 1, the sheet P is fed to an intermediate transport means 60. Once inside the intermediate transport means 60, the sheet is transported by intermediate transport rollers 61 to a post-processing device 62. A paper discharge tray 63 on which the sheets P pile up is present at the bottom of the post-processing device 62.

A secondary fixing unit 64 is installed above the piled sheets P. To produce a booklet, once the sheets P are piled up on the paper discharge tray 63, the secondary fixing unit 64 descends then in the direction of the black arrow P1, and a bonding process is carried out. FIG. 16A and FIG. 16B are schematic diagrams of a booklet-shaped deliverable obtained on the basis of the configuration of Example 2. To produce booklet, a powder is printed on a powder adhesive Tn print region 65. A booklet deliverable can thereupon be obtained through bonding of the powder adhesive Tn print region 65 at the secondary fixing unit 64.

In the comparative experiment conducted in Example 2, the fixing state in the secondary fixing unit 64 was as good as in Example 1, and accordingly the results remained unchanged. By adopting the configuration of Example 2 it becomes therefore possible to provide an image forming apparatus capable of producing good booklets.

### Example 3

Unless otherwise noted, the configuration herein is identical to that in Example 1.

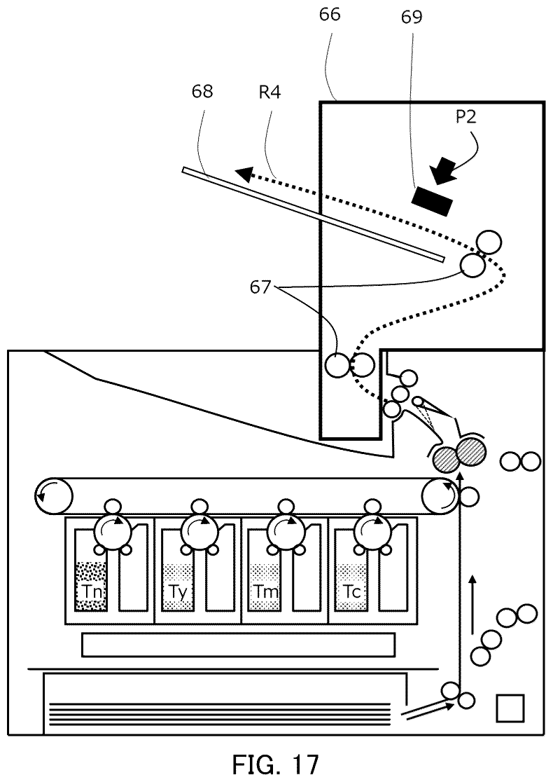

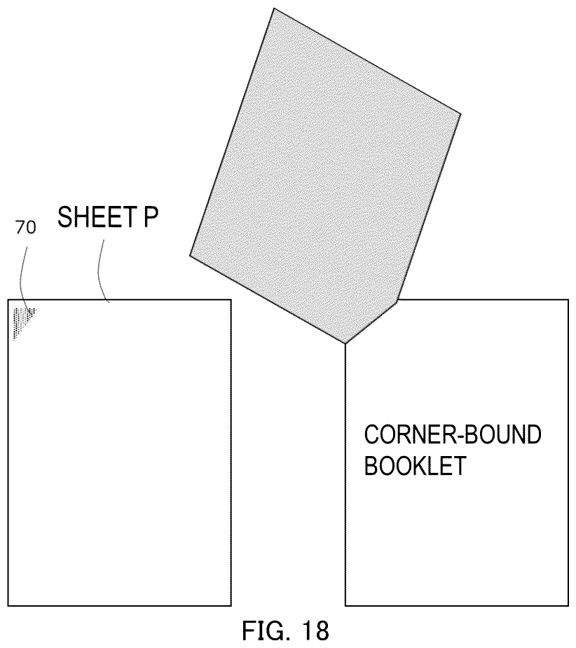

Example 3 differs as regards the deliverable that is obtained, and also as regards the features of a bonding process. A relevant explanation follows with reference to FIG. 17 and FIG. 18. FIG. 17 is a schematic diagram of an image forming apparatus of Example 3. In Example 3 a corner-bound booklet can be produced in a post-processing step. The sheet P discharged from the image forming apparatus 1 passes along a path denoted a dotted arrow R4. Specifically, after having been transported to the post-processing device 66, the sheet P is transported towards a paper discharge tray 68 by transport rollers 67. A secondary fixing unit 69 is provided above the paper ejection tray, to bond a corner of the discharged sheets P.

FIG. 18 is a schematic diagram of a corner-bound booklet-shaped deliverable obtained on the basis of the configuration of Example 3. To produce a corner-bound booklet, a powder is printed on a powder adhesive Tn print region 70. A corner-bound booklet deliverable can thereupon be obtained through bonding of the powder adhesive Tn print region 70 in the secondary fixing unit 69.

In the comparative experiment conducted in Example 3 the fixing state in the secondary fixing unit 69 was as good as in Example 1, and accordingly the results remained unchanged. By adopting the configuration of Example 3, it becomes therefore possible to provide an image forming apparatus capable of producing good corner-bound booklets.

The configurations of the present disclosure is summarized below.

### Configuration Example 1

An image forming apparatus, comprising:
a first image forming section for forming a printing toner image by a printing toner; and
a second image forming section for forming a powder adhesive image by a powder adhesive,
wherein the printing toner comprises a wax;
the powder adhesive comprises a wax; and
a content of the wax in the powder adhesive is higher than a content of the wax in the printing toner.

### Configuration Example 2

The image forming apparatus according to configuration example 1,
wherein the wax comprised in the printing toner comprises a plasticizer;
the wax comprised in the powder adhesive comprises a plasticizer; and
a content of the plasticizer in the powder adhesive is higher than a content of the plasticizer in the printing toner.

### Configuration Example 3

The image forming apparatus according to configuration example 2,
wherein the plasticizer in the printing toner is an ester wax;
the plasticizer in the powder adhesive is an ester wax; and
a content of the ester wax in the powder adhesive is higher than a content of the ester wax in the printing toner.

### Configuration Example 4

The image forming apparatus according to any one of configuration examples 1 to 3, wherein a weight-average particle diameter of the powder adhesive is 5 to 20 μm.

### Configuration Example 5

The image forming apparatus according to any one of configuration examples 1 to 4, wherein a weight-average particle diameter of the powder adhesive is larger than a weight-average particle diameter of the printing toner.

### Configuration Example 6

The image forming apparatus according to any one of configuration examples 1 to 5,
wherein the first image forming section has a first image bearing member, and a first developer bearing member developing, with the printing toner, an electrostatic latent image formed on the first image bearing member;
the second image forming section has a second image bearing member, and a second developer bearing member developing, with the powder adhesive, an electrostatic latent image formed on the second image bearing member; and
a laying amount of the powder adhesive per unit area on the second developer bearing member is larger than a laying amount of the printing toner per unit area on the first developer bearing member.

### Configuration Example 7

An adhesive cartridge detachably mountable to an image forming apparatus having a first image forming section for forming a printing toner image by a printing toner comprising a wax,
wherein the adhesive cartridge has a second image forming section for forming a powder adhesive image by a powder adhesive,
the powder adhesive comprises a wax; and
a content of the wax in the powder adhesive is higher a content of the wax in the printing toner.

### Configuration Example 8

The adhesive cartridge according to configuration example 7,
wherein the wax comprised in the printing toner comprises a plasticizer;
the wax comprised in the powder adhesive comprises a plasticizer; and
a content of the plasticizer in the powder adhesive is higher than a content of the plasticizer in the printing toner.

### Configuration Example 9

The adhesive cartridge according to configuration example 8,
wherein the plasticizer in the printing toner is an ester wax;
the plasticizer in the powder adhesive is an ester wax; and
a content of the ester wax in the powder adhesive is higher than a content of the ester wax in the printing toner.

### Configuration Example 10

The adhesive cartridge according to any one of configuration examples 7 to 9, wherein a weight-average particle diameter of the powder adhesive is 5 to 20 μm.

### Configuration Example 11

The adhesive cartridge according to any one of configuration examples 7 to 10, wherein a weight-average particle diameter of the powder adhesive is larger than a weight-average particle diameter of the printing toner.

### Configuration Example 12

The adhesive cartridge according to any one of configuration examples 7 to 11,
wherein the first image forming section has a first developer bearing member developing, with the printing toner, an electrostatic latent image formed on a first image bearing member;
the second image forming section has a second developer bearing member developing, with the powder adhesive, an electrostatic latent image formed on a second image bearing member; and
a laying amount of the powder adhesive per unit area on the second developer bearing member is larger than a laying amount of the printing toner per unit area on the first developer bearing member.

### Configuration Example 13

The adhesive cartridge according to configuration example 12, wherein the second image forming section has the second image bearing member.

### Configuration Example 14

The adhesive cartridge according to configuration example 12 or 13, wherein the first image forming section is detachably mountable to the image forming apparatus.

### Configuration Example 15

The adhesive cartridge according to configuration example 14, wherein the first image forming section has the first image bearing member.

### Configuration Example 16

An adhesive container detachably mountable to an image forming apparatus,
wherein the adhesive container has a first image forming section for forming a printing toner image by a printing toner comprising a wax, and a second image forming section for forming a powder adhesive image by a powder adhesive,
the adhesive container has a powder accommodating section accommodating a powder adhesive,
the powder adhesive accommodated in the powder accommodating section comprises a wax; and
a content of the wax in the powder adhesive is higher a content of the wax in the printing toner.

### Configuration Example 17

The adhesive container according to configuration example 16,
wherein the wax comprised in the printing toner comprises a plasticizer;
the wax comprised in the powder adhesive comprises a plasticizer; and
a content of the plasticizer in the powder adhesive is higher than a content of the plasticizer in the printing toner.

### Configuration Example 18

The adhesive container according to configuration example 17,
wherein the plasticizer in the printing toner is an ester wax;
the plasticizer in the powder adhesive is an ester wax; and
a content of the ester wax in the powder adhesive is higher than a content of the ester wax in the printing toner.

### Configuration Example 19

The adhesive container according to any one of configuration examples 16 to 18, wherein a weight-average particle diameter of the powder adhesive is 5 to 20 μm.

### Configuration Example 20

The adhesive container according to any one of configuration examples 16 to 19, wherein a weight-average particle diameter of the powder adhesive is larger than a weight-average particle diameter of the printing toner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image forming apparatus, comprising:
a first image forming section for forming a printing toner image by a printing toner; and
a second image forming section for forming a powder adhesive image by a powder adhesive,
wherein the printing toner comprises a wax comprising an ester wax and a hydrocarbon wax;
the powder adhesive comprises a wax; and
a content of the wax in the powder adhesive is higher than a content of the wax in the printing toner.

2. The image forming apparatus according to claim 1,
wherein the powder adhesive comprises an ester wax; and
a content of the ester wax in the powder adhesive is higher than a content of the ester wax in the printing toner.

3. The image forming apparatus according to claim 1, wherein a weight-average particle diameter of the powder adhesive is 5 to 20 μm.

4. The image forming apparatus according to claim 1, wherein a weight-average particle diameter of the powder adhesive is larger than a weight-average particle diameter of the printing toner.

5. The image forming apparatus according to claim 1,
wherein the first image forming section has a first image bearing member, and a first developer bearing member developing, with the printing toner, an electrostatic latent image formed on the first image bearing member;
the second image forming section has a second image bearing member, and a second developer bearing member developing, with the powder adhesive, an electrostatic latent image formed on the second image bearing member; and
a laying amount of the powder adhesive per unit area on the second developer bearing member is larger than a laying amount of the printing toner per unit area on the first developer bearing member.

6. An adhesive cartridge detachably mountable to an image forming apparatus having a first image forming section for forming a printing toner image by a printing toner comprising a wax,
wherein the wax comprised in the printing toner comprises an ester wax and a hydrocarbon wax,
the adhesive cartridge has a second image forming section for forming a powder adhesive image by a powder adhesive,
the powder adhesive comprises a wax; and
a content of the wax in the powder adhesive is higher a content of the wax in the printing toner.

7. The adhesive cartridge according to claim 6,
wherein the powder adhesive comprises an ester wax; and
a content of the ester wax in the powder adhesive is higher than a content of the ester wax in the printing toner.

8. The adhesive cartridge according to claim 6, wherein a weight-average particle diameter of the powder adhesive is 5 to 20 μm.

9. The adhesive cartridge according to claim 6, wherein a weight-average particle diameter of the powder adhesive is larger than a weight-average particle diameter of the printing toner.

10. The adhesive cartridge according to claim 6,
wherein the first image forming section has a first developer bearing member developing, with the printing toner, an electrostatic latent image formed on a first image bearing member;
the second image forming section has a second developer bearing member developing, with the powder adhesive, an electrostatic latent image formed on a second image bearing member; and
a laying amount of the powder adhesive per unit area on the second developer bearing member is larger than a laying amount of the printing toner per unit area on the first developer bearing member.

11. The adhesive cartridge according to claim 10, wherein the second image forming section has the second image bearing member.

12. The adhesive cartridge according to claim 10, wherein the first image forming section is detachably mountable to the image forming apparatus.

13. The adhesive cartridge according to claim 12, wherein the first image forming section has the first image bearing member.

14. An adhesive container detachably mountable to an image forming apparatus,
wherein the adhesive container has a first image forming section for forming a printing toner image by a printing toner comprising a wax, and a second image forming section for forming a powder adhesive image by a powder adhesive,
the adhesive container has a powder accommodating section accommodating a powder adhesive,
the wax comprised in the printing toner comprises an ester wax and a hydrocarbon wax;
the powder adhesive accommodated in the powder accommodating section comprises a wax; and
a content of the wax in the powder adhesive is higher a content of the wax in the printing toner.

15. The adhesive container according to claim 14,
wherein the powder adhesive comprises an ester wax; and
a content of the ester wax in the powder adhesive is higher than a content of the ester wax in the printing toner.

16. The adhesive container according to claim 14, wherein a weight-average particle diameter of the powder adhesive is 5 to 20 μm.

17. The adhesive container according to claim 14, wherein a weight-average particle diameter of the powder adhesive is larger than a weight-average particle diameter of the printing toner.

18. The image forming apparatus according to claim 1,
wherein the powder adhesive comprises an ester wax and a hydrocarbon wax,
a content of the ester wax in the powder adhesive is higher than a content of the ester wax in the printing toner.

19. The image forming apparatus according to claim 2,
wherein the ester wax comprised in the powder adhesive comprises a compound represented by Formula (3) below: 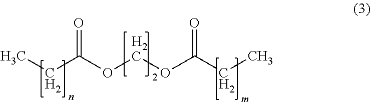
in Formula (3), n and m each independently represents a positive integer from 16 to 22.

20. The image forming apparatus according to claim 1,
wherein the ester wax comprised in the printing toner comprises a compound represented by Formula (3) below: 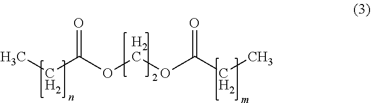
in Formula (3), n and m each independently represents a positive integer from 16 to 22.

21. The adhesive cartridge according to claim 6,
wherein the powder adhesive comprises an ester wax and a hydrocarbon wax,
a content of the ester wax in the powder adhesive is higher than a content of the ester wax in the printing toner.

22. The adhesive cartridge according to claim 7,
wherein the ester wax comprised in the powder adhesive comprises a compound represented by Formula (3) below: 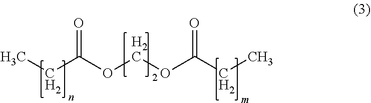
in Formula (3), n and m each independently represents a positive integer from 16 to 22.

23. The adhesive cartridge according to claim 6,
wherein the ester wax comprised in the printing toner comprises a compound represented by Formula (3) below: 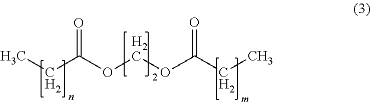
in Formula (3), n and m each independently represents a positive integer from 16 to 22.

24. The adhesive container according to claim 14,
wherein the powder adhesive comprises an ester wax and a hydrocarbon wax,
a content of the ester wax in the powder adhesive is higher than a content of the ester wax in the printing toner.

25. The adhesive container according to claim 15,
wherein the ester wax comprised in the powder adhesive comprises a compound represented by Formula (3) below: 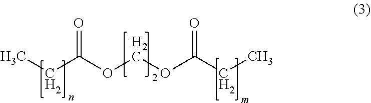
in Formula (3), n and m each independently represents a positive integer from 16 to 22.

26. The adhesive container according to claim 14,
wherein the ester wax comprised in the printing toner comprises a compound represented by Formula (3) below: 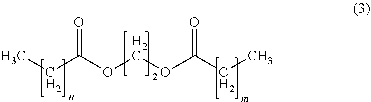
in Formula (3), n and m each independently represents a positive integer from 16 to 22.
